(19) United States
(12) Patent Application Publication
(10) Pub. No.: US 2026/0336151 A1
(43) Pub. Date: Oct. 29, 2026

(54) METHOD FOR OBTAINING OUTLET OPENINGS OF A CAPSULE

(71) Applicant: SOCIÉTÉ DES PRODUITS NESTLÉ S.A., Vevey (CH)

(72) Inventors: Arnaud GERBAULET, Oye et Pallet (FR); Cedric RICHARD, Poliez-Pittet (CH); Veith BEHRMANN, Villeneuve (CH); Rolf ZWALHEN, Mittelhäusern (CH)

(21) Appl. No.: 19/110,984

(22) PCT Filed: Sep. 21, 2023
(86) PCT No.: PCT/EP2023/076033

§ 371 Date: Mar. 12, 2025

(30) Foreign Application Priority Data
Sep. 22, 2022 (EP) 22197215.1

(51) Int. Cl. B26F 1/04; B26F 1/38; B65D 85/804

(52) U.S. Cl. CPC B26F 1/04; B26F 1/3846; B65D 85/8052

(57) ABSTRACT

The invention relates to a method for obtaining at least outlet openings (8) for a carrier disk (7) that can be provided in an inner space of a capsule (1) for preparing a beverage, wherein the outlet openings (8) are suitable for draining the prepared beverage from the inner space towards an outside of the capsule (1) when the capsule (1) is used in the beverage preparation device. The method comprises the steps of:—providing a sheet material (70) from which the carrier disk (7) with the outlet openings (8) can be obtained, cutting, by a cutting device, the sheet material (70) to obtain a first set of the outlet openings (8),—aligning, by an alignment element (101) extending through an alignment opening (71) provided in the sheet material (70), the first set of the outlet openings relative to the cutting device,—cutting, by the cutting device, the sheet material (70) with the so aligned first set of the outlet openings to obtain a second set of the outlet openings, and—moving the sheet material (70) relative to the cutting device intermittently along different distances.

### FIELD OF THE INVENTION

The invention relates to a method for at least obtaining outlet openings for a carrier disk of a capsule integrating a filter element for preparing a beverage, preferably a crema-free coffee, tea, milk or chocolate-based beverage.

### BACKGROUND OF THE INVENTION

Capsules for preparing a beverage in a beverage preparation device, and presenting said features are generally known from the prior art. The beverage preparation device comprises a brewing chamber in which the capsule is positioned. Liquid from the beverage preparation device is injected in the capsule to extract the beverage from an extractable ingredient, usually roasted and ground coffee or tea, or to prepare the beverage from a soluble ingredient, usually instant coffee, instant tea or instant milk or chocolate-based product, contained within an inner space of the capsule.

In most of the capsules currently on the market, the inner space of the capsule is closed, hermetically or fluid-tightly closed from the environment prior to be used in the beverage preparation device in order to maintain or prolong a freshness of the beverage ingredient during storage.

The capsule hereto often comprises a substantially rigid capsule body having a circumferential sidewall extending around the inner space and a base wall covering the inner space at a first end of the sidewall. At a second end of the sidewall opposite the base wall the capsule body has an open filling side. A fluid and gas tight lid, for example an aluminum lid, is provided over the open filling side of the capsule body to cover the inner space. In use the capsule may be pierced, preferably at the base wall and/or the lid, to form an injection opening for injecting the liquid such as hot water, and/or to form an outlet opening which allows the prepared beverage to escape the capsule.

The known capsules are more particularly conceived for preparing an espresso type beverage using beverage preparation device delivering high pressurized hot water wherein the injection of pressurized hot water in the capsule leads to an extraction of substances from the coffee beverage ingredient and with foam forming on the beverage corresponding to an espresso beverage with a crema layer as obtained with known piston type espresso machine using high pressure brewing.

For a crema-free coffee beverage, for example a coffee beverage without foam, also referred to as filter coffee, usually specific apparatuses are used in which the beverage is prepared by unpressurized filtration of a mixture of beverage ingredient and water.

Some capsules to be used in pressurized beverage devices have been proposed for the preparation of crema free coffee.

EP 2952125 A1 discloses a capsule for preparing a beverage using an extractable product contained in an inner space of the capsule. The capsule comprises a circumferential first wall, a second wall closing the circumferential first wall at a first end, and a flexible sheet-shaped perforate and/or porous third wall closing the circumferential first wall at a second, open end opposite the second wall, thereby forming the said inner space. The third wall forms an outermost boundary of the capsule in an axial direction thereof and comprises a woven or nonwoven filtering material, such as filtering paper.

WO 2019/013623 A1 proposes a capsule comprising a rigid capsule body with a circumferential wall and a base wall that border an inner space filled with a beverage ingredient. An open filling side of the capsule at an end of the circumferential wall opposite the base wall is covered with a lid of fluid tight material. The lid is provided with a preformed outlet opening suitable for draining the prepared beverage from the inner space when the capsule is used in a beverage preparation device. The outlet opening is fluid tightly closed by a removable cover element extending over at least part of the lid.

However, these solutions are not fully satisfactory in what concerns the construction of the capsule, the ergonomic use of it by the consumer and the obtained in-cup result. Further, there is a need to manufacture parts of the capsule cost-effectively but at the same time precisely, in particular such that the obtained in-cup result has a high quality.

It is therefore an object of the proposed invention to provide a method for obtaining at least parts of a capsule, which is suitable for producing a filter type coffee beverage with no crema which has all the characteristics of a filter coffee made with drip coffee machine and comply with expected sensory in-cup results expected by the consumer, cost-effectively but at the same time precisely.

### SUMMARY OF THE INVENTION

In this respect, the invention provides a method for obtaining at least outlet openings for a carrier disk that can be provided in an inner space of a capsule for preparing a beverage, wherein the outlet openings are suitable for draining the prepared beverage from the inner space towards an outside of the capsule when the capsule is used in the beverage preparation device, wherein the method comprises the steps of:
providing a sheet material from which the carrier disk with the outlet openings can be obtained,
cutting, by a cutting device, the sheet material to obtain a first set of the outlet openings,
aligning, by an alignment element extending through an alignment opening (a guiding hole, a centering hole, a positioning hole, a reference hole, etc.) provided in the sheet material, the first set of the outlet openings relative to the cutting device, and
cutting, by the cutting device, the sheet material with the so aligned first set of the outlet openings to obtain a second set of the outlet openings.

In particular, “aligning” may comprise a guiding, a centering, and/or a positioning relative to the cutting device. By the alignment element extending though the alignment opening, at least the first set of the outlet openings may be automatically centered relative to the cutting device. Thus, the alignment opening may be used in the cutting device to “auto center” the cutting of the holes.

Accordingly, the first set of the outlet openings and the second set of the outlet openings, which together form at least part of the outlet openings of the carrier disk to be obtained from the sheet material, can be manufactured very precisely, i.e. with high accuracy. This because the step of aligning the first set of the outlet openings relative to the cutting device ensures that the second set of the outlet openings is being cut in a defined manner relative to the first set of the outlet openings. Thereby, the second set can be precisely provided relative to the first set, in particular such that outlet openings of a set, which is composed of outlet openings of the first set and of outlet openings of the second set, are evenly (i.e. homogeneously) distributed. In particular, the at least first and second sets of outlet openings may be obtained such that these sets are adjacent to each other or overlap with one another. The sets of outlet openings overlapping with one another means that at least some outlet openings of one of the sets are arranged among at least some outlet openings of the respective other of the sets such that each outlet opening comprised by the so formed overlap does not merge with another outlet opening.

In particular, the so obtained outlet openings comprising at least the first set and the second set of the outlet openings can be arranged very close to each other, whereby it is possible to obtain a carrier disk with a particularly high number of outlet openings that are precisely arranged to each other. Further, the so obtained precisely arranged outlet openings do not require a complex manufacturing equipment, because the method makes it in particular possible that a very high number of outlet openings, which are arranged very close to one another, is not required to be obtained in a single cutting step. Rather, a very high number of outlet openings, which are furthermore arranged very close to one another in a precise manner, is obtained in at least two cutting steps or, in other words, is split into, or spread over, several cutting steps, e.g. with a reduced number of cutting stations. Thereby, in particular cutting pressures and a space required for the cutting device can be reduced. The latter in particular because the cutting device is not required to provide a very high number of outlet openings at once. Instead, the cutting device may be adapted to provide only a fraction of the total number of the outlet openings of the carrier disk, which saves space. In other words, at least part of the outlet openings of the carrier disk may be provided by cutting the first set of the outlet openings by the cutting device, advancing or moving the sheet material relative to the cutting device, aligning the first set of the outlet openings, and then cutting, by the cutting device, the second set of the outlet openings having the same hole pattern.

Further, the obtaining of the outlet openings of the carrier disk in at least two cutting steps provides the advantage that during the overall cutting process a particularly low amount of small particles, which break off during cutting as waste, is achieved. Accordingly, the material efficiency is improved.

The so obtained outlet openings, which are arranged in a very precise manner (e.g., obtained with a tolerance of less than 0.1 mm) and, preferably, provided in a very high number, can be advantageously used in a carrier disk of a capsule for the preparation of a beverage. For example, when the capsule comprises roast and ground coffee as a beverage ingredient, the specific structure of the carrier disk defined, in particular, by the outlet openings allows when the capsule is extracted in a beverage preparation after removal of the lid to get a coffee with limited formation of foam and crema. This freshly brewed coffee may have the main characteristics of a filter-like coffee with little crema, quickly disappearing (in less than 1 or 2 mins) to leave only a crown of crema around the cup. The result-in-cup is a coffee having a low body, little acidity, and little bitterness with absence of harsh, while being aromatic, soft, smooth and sweet. In particular, the outlet openings may be obtained in such a way that, when comprised by the carrier disk provided in the inner space of the capsule, possible channeling of the water within the coffee bed (in the capsule) during extraction is avoided.

In the context of the present invention, “cutting” is to be understood as encompassing different cutting technologies or cutting methods. For example, cutting may comprise, or may be, punching. Additionally or alternatively, cutting may comprise, or may be, cutting by using heat (e.g., by using a laser) and/or by using chip forming (e.g., drilling) and/or by using other methods involving shearing.

The method may comprise a step of detecting the alignment opening and, wherein, once detected, the step of aligning is carried out, in which the alignment element moves in order to extend through the so detected alignment opening. The detection may be carried out by an optical device.

The method may further comprise the steps of: aligning, by the alignment element extending through a further (e.g. second) alignment opening (a guiding hole, a centering hole, a positioning hole, etc.) provided in the sheet material, the sets of the outlet openings relative to the cutting device; and cutting, by the cutting device, the sheet material with the so aligned sets of the outlet openings to obtain a further, such as a third, set of the outlet openings. Accordingly, the same alignment element may be used for aligning the first set of the outlet openings and for aligning, in a further aligning step, at least the first and second sets of the outlet openings relative to the cutting device so that, in a subsequent cutting step, a third set of the outlet openings is obtained, e.g. adjacent to the second set of the outlet openings. Hence, obtaining a high number of outlet openings with high accuracy is even more simplified. For example, the further (or third) set of the outlet openings has a hole pattern that is identical to the hole pattern of each of the first and second sets.

The method may further comprise the steps of: aligning, by a further (such as a second) alignment element extending through the alignment opening provided in the sheet material, the sets (such as the first to third sets) of the outlet openings relative to the cutting device; and cutting, by the cutting device, the sheet material with the so aligned sets of the outlet openings to obtain an additional (or a yet further, e.g. a fourth) set of the outlet openings. The further alignment element may align the sets of the outlet openings relative to a part of the cutting device, which part is different from the part of the cutting device relative to which the (first) alignment element aligns the at least first set of the outlet openings. Thereby, it is in particular possible that the additional set of the outlet openings has a hole pattern different from the hole pattern of each of the first and/or the second and/or, if present, the third set of the outlet openings. Accordingly, outlet openings can be obtained in a very advantageous manner, e.g. by comprising overlapping sets of the outlet openings with different hole patterns, respectively.

The method may further comprise the steps of: aligning, by the further alignment element extending through the further alignment opening provided in the sheet material, the sets (such as the first to fourth sets) of the outlet openings relative to the cutting device; and cutting, by the cutting device, the sheet material with the so aligned sets of the outlet openings to obtain a yet further (or even yet further, e.g. fifth) set of the outlet openings. For example, the same alignment element may be used for aligning the first to third sets of the outlet openings and for aligning, in a further aligning step, the first to fourth sets of the outlet openings so that, in a subsequent cutting step, the fifth set of the outlet openings is obtained, e.g. adjacent to the fourth set of the outlet openings but overlapping with one or more of the first to third sets of the outlet openings. For example, the yet further (or fifth) set of the outlet openings has a hole pattern that is identical to the hole pattern of the fourth set.

The method may further comprise the steps of: aligning, by the further alignment element extending through an additional (or a yet further, e.g. a third) alignment opening provided in the sheet material, the sets (such as the first to fifth sets) of the outlet openings relative to the cutting device; and cutting, by the cutting device, the sheet material with the so aligned sets of the outlet openings to obtain an additional (such as a sixth) set of the outlet openings. For example, the sixth set of the outlet openings has a hole pattern that is identical to the hole pattern of each of the fourth and fifth sets.

At least part of the outlet openings of one set of the outlet openings may be arranged among the outlet openings of the respective other set of the outlet openings. In other words, the one set may overlap with the respective other set. For example, the other set may be provided such that at least part of the openings are surrounded by a section of the sheet material, wherein at least one outlet openings of the one set is cut in this section of the sheet material, whereby this outlet opening is arranged among the outlet openings of the other set. Thereby, a particularly high number of outlet openings can be arranged closed to one another in a precise manner.

The method may further comprise the step of cutting, by the cutting device, the sheet material to obtain the alignment opening. In particular, the alignment opening may be obtained in the step of cutting to obtain the first set of the outlet openings. For example, the cutting step to cut the sheet material to obtain the first set of the outlet openings may effect a hole pattern that includes the alignment opening. The cutting device may have a first cutter for obtaining the first set of the outlet openings and a second cutter for obtaining the alignment opening, wherein these cutters are, during cutting, in a fixed distance to each other. The further alignment opening may be obtained in the step of cutting to obtain the second set of the outlet openings. The additional alignment opening may be obtained in the step of cutting to obtain the further set of the outlet openings. The further alignment opening and/or the additional alignment opening may be obtained by the same cutter that obtains the alignment opening.

In other words, the first, second (or further), third (or additional) alignment openings may be formed together with the first, second and third (or further) set of the outlet openings, respectively. The method may thus further comprise the step of cutting, by the cutting device, the sheet material to obtain the alignment openings, wherein, for example, the alignment opening is obtained in the step of cutting to obtain the first set of the outlet openings, the further alignment opening is obtained in the step of cutting to obtain the second set of the outlet openings and the additional alignment opening is obtained in the step of cutting to obtain the third (or further) set of the outlet openings.

The alignment opening, and optionally the further alignment opening and, if present, the additional alignment opening, may have a diameter greater than the diameter of each of the outlet openings. The alignment element may be a pin such as a pilot pin. The alignment opening may have a diameter greater than each of the outlet openings but equal or (slightly) smaller than the diameter of the alignment opening. The alignment element may be adapted to extend through one or more alignment openings in order to align one or more sets of the outlet openings relative to the cutting device. During the step of aligning, a feeder that feeds the sheet material may allow for a movement of the sheet material relative to the cutting device (i.e., the feeder releases the sheet material, e.g., the feeder does not tense the sheet material) so that, by moving the alignment element through the alignment opening, the sheet material with the at least first set of the outlet openings can be precisely positioned relative to the cutting device. Then, the feeder may prevent at least the portion of the sheet material with the at least first set of the outlet openings from moving relative to the cutting device (e.g., by tensioning at least part of the sheet material) so that the sheet material can be cut in an easy manner.

The method further comprises the step of moving the sheet material relative to the cutting device intermittently along different distances (or stroke advances or step lengths). The different distances may comprise at least two or at least three (short) distances and at least one (long) distance that is greater than each of the (short distances) The sheet material may thus move during a first phase and stop during a second phase, wherein during the second phase at least the steps of aligning one or more sets of the outlet openings and cutting a further set of the outlet openings are carried out. In other words, the sheet material may move relative to the cutting device by non-regular stroke advances, such as three times by a stroke advance of a distance A and a fourth time by a stroke advance of a distance B, with B being different from (e.g. greater than) A. During a movement of the sheet material (i.e. when the sheet material advances), the alignment element may be in a first position (such as a retracted position or an upper position) in which the alignment element is distanced from the sheet material. When the sheet material is stopped, the alignment element may be in a second position (such as an extended position or a lower position into which the alignment element is moved downward from the upper position) in which the alignment element extends through the alignment opening for aligning at least the first set of the outlet openings. By moving the sheet material relative to the cutting device intermittently along different distances, a complex pattern of the outlet openings of a (single) carrier disk (such as interleaved sets of outlet openings forming the outlet openings of the carrier disk) can be obtained in a very easy manner.

The method may further comprise the step of moving the sheet material relative to the cutting device from a first position, in which the first set of the outlet openings is obtained, along a distance (such as a stroke) to a second position, in which the second set of the outlet openings is obtained. The cutting device may be stationary, while the sheet material moves. Alternatively, the sheet material may be stationary, while the cutting device moves. In both positions, the same hole pattern (e.g. by using the same cutting station) or different hole patterns (e.g., by using different cutting stations, respectively) may be obtained.

The method may further comprise the step of moving the sheet material relative to the cutting device from the second position along a further (second) distance to a third position, in which the further (such as third) or the additional (such as fourth) set of the outlet openings is obtained, wherein the further distance equals, or is greater than, the distance. For example, the further distance equals the distance when in all of the three positions the same hole pattern is obtained. The further distance may be greater than the distance when in the third position a different hole pattern than in the second position is obtained. For example, the greater distance may be used to move the sheet material to a different cutting station, such as a different punch.

The method may further comprise the step of: cutting, by the cutting device, the sheet material to obtain the carrier disk such that the carrier disk comprises the sets of the outlet openings. The step of cutting the sheet material to obtain the carrier disk may be carried out in a production line different from the production line in which the at least first and second sets of outlet openings are obtained. In other words, the cutting device may comprise a first part (such as one or more first cutting stations) for obtaining the at least first and second sets of outlet openings, and a second part (such as one or more second cutting stations) for obtaining the carrier disk, wherein the second part may be at a different location than the first part.

The method may further comprise the step of: aligning, by using an alignment element extending through the alignment opening and/or, if present, through another alignment opening provided in the sheet material, such as through the further alignment opening or the additional alignment opening, the sets of the outlet openings relative to the cutting device; and cutting, by the cutting device (or by a cutting station different and/or distanced from the one or more cutting stations to obtain at least the first and second sets), the sheet material to obtain the carrier disk such that the carrier disk comprises the so aligned sets of the outlet openings. Thereby, the outlet openings can be provided very precisely in the carrier disk, in particular with a defined distance to the perimeter of the carrier disk or at least positioned within the circumferential cut line. In particular, it is avoided that the cutting device cuts through the outlet openings provided in the sheet material. In particular, the carrier disk may be obtained such that the carrier disk is void of outlet openings on its external perimeter over a distance of at least 1 mm, preferably over a distance comprised between 0.5 and 2.5 mm and more preferably between 1 and 2 mm. Thereby, safe and easy assembling in the capsule may be allowed.

Obtaining the outlet openings for the carrier disk may be a first production step, wherein obtaining the carrier disk to comprise these outlet openings may be a second production step. The first and second production steps may be carried out on different production lines, respectively. For example, the production lines are independent from one another (in particular, independently operable from one another) and/or distances from one another. The first production step may be at a first supplier's site, wherein the second production step may be at a second supplier's site. Between the production steps, the sheet material comprising the outlet openings may be transported (e.g. as a sheet roll). Obtaining the carrier disk, or said second production step may be part of a filler device or machine or of a filler line. In the filler device or machine, or filler line, a capsule body may be filled with a beverage ingredient, wherein after this filling step, the sheet material may be cut to obtain the carrier disk (e.g. along with a filter element). After obtaining the carrier disk, the carrier disk (and, for example, at the same time the filter element) may be transferred on or in the capsule.

In particular, the carrier disk may be obtained (e.g., punched) in register to the hole pattern defined by the at least two sets of the outlet openings.

The cutting device may be a punching device, wherein, preferably, cutting the at least first and second sets of the outlet openings is carried out by a same punch or by different punches, respectively. The punching device may comprise one or more dies arranged opposite the same punch or the different punches. By the punching device, the sets of the outlet openings can be obtained by a back and forth movement, such as by moving a punch down and moving the punch up.

The method may further comprise the step of providing the carrier disk in an inner space of a capsule for preparing a beverage.

The method may further comprise the step of providing a filter element. The filter element may comprise a layer of non-woven material adapted to prevent coffee drain to go through and reducing the formation of a crema layer.

The method may be carried out in a multilane production line or in a multilane machine.

The method may comprise the step of filling, such as of filling a beverage ingredient into a capsule body. After being filled with the beverage ingredient, a carrier disk comprising the at least two sets of outlet openings may be provided in the capsule body. In other words, the method may be used in a multilane filling machine or line. Filling may be carried out by one or more filling stations such as at least two filling stations, preferably six or more filling stations, more preferably eight or more filling stations, even more preferably twelve or more filling stations, for example twenty-four or more filling stations.

The method may further comprise the step of positioning the filter element on the carrier disk. This allows an easy processing in the assembling process of the capsule. Additionally, the method may comprise the step of fixing the filter element (e.g. positioned on the carrier disk) onto the carrier disk.

An outlet opening of one set of the outlet openings may be spaced apart from an adjacent outlet opening of another set of the outlet openings with a distance comprised between 0.5 mm and 3 mm and more preferably between 1 mm and 3 mm. In particular, an outlet opening of one set of the outlet openings that is arranged among the outlet openings of the another set of the outlet openings may be spaced apart from these outlet openings with a distance comprised between 0.5 mm and 3 mm and more preferably between 1 mm and 3 mm.

Adjacent outlet openings of a same set of the outlet openings may be spaced apart from one another with a distance greater than the distance between adjacent outlet openings of different sets of the outlet openings.

The sets of the outlet openings or the outlet openings of the carrier disk, in particular the sets of the outlet openings comprised by the carrier disk, may comprise between 50 and 150 outlet openings, preferably between 70 and 120 outlet openings, more preferably between 85 and 110 outlet openings. Such a structure with multiple openings is in particular advantageous to avoid possible channeling of the water within the coffee bed during extraction.

The sets of the outlet openings or the outlet openings of the carrier disk, in particular the sets of the outlet openings comprised by the carrier disk, may comprise between 0.07 and 0.21 outlet openings per mm², preferably between 0.10 and 0.17 outlet openings per mm², more preferably between 0.12 and 0.16 outlet openings per mm².

The open surface ratio of the carrier disk may be comprised between 4% and 15%, preferably between 5 and 12%. The set open surface ratio allows that no or reduced pressure building occurs in the capsule during extraction.

The outlet openings may be calibrated circular or oblong openings. Such shapes of outlet openings shape are optimized for an easy manufacturing and a lower tooling cost. However, other shapes of the outlet opening may be selected depending on the result in cup to be obtained.

The outlet openings may have a diameter comprised between 0.4 mm and 3 mm, preferably between 0.5 mm and 2 mm, more preferably between 0.5 mm and 1.3 mm. These dimensions have been calculated for a leak rate of approximately 300 ml/min.

The outlet openings may be homogeneously distributed on the surface of the carrier disk. This contributes to avoiding the channeling effect.

Each outlet opening of the carrier disk may be spaced apart from an adjacent outlet opening with a distance comprised between 0.5 mm and 3 mm and more preferably between 1 mm and 3 mm.

The carrier disk may have a generally circular shape with a diameter comprised between 28.5 mm and 30.5 mm. Alternatively, the carrier disk may have another shape, such as an oval, polygonal, or rectangular shape.

The thickness of the sheet material or of the carrier disk may be comprised between 0.05 mm and 1.5 mm, preferably between 0.1 mm and 1 mm, most preferably between 0.2 mm and 0.8 mm. Thereby, the carrier disk has enough stiffness to resist to ejection during extraction, or after extraction due to the pressure of the swollen coffee bed. In an embodiment, the thickness of the sheet material is about 0.3 mm (300 μm).

The sheet material may be made of aluminum. This allows an easy recycling in the conventional aluminum stream, in particular when the remaining capsule is also made of aluminum. Additionally or alternatively, the carrier disk may be made of plastic or of a laminated plastic element.

The sheet material may be provided as a sheet roll or from a sheet roll. The sheet roll may have such a width (e.g., the extension of the sheet material transverse to the moving direction of the sheet material) that is greater than at least two times the diameter of the carrier disk which is to be obtained from the sheet material. The sheet material may be in the form of a foil.

According to a further aspect, the invention provides a capsule for preparing a beverage. The capsule comprises:
a substantially rigid capsule body having a circumferential sidewall extending around an inner space of the capsule, said inner space being at least partially filled with a beverage ingredient suitable for preparing the beverage,
a rigid base wall, integral with the capsule body, the base wall covering the inner space at a first end of the sidewall,
a flange arranged circumferentially around an open side of the capsule at a second end of the sidewall of the base body opposite the base wall,
a lid covering the inner space and the open side of the capsule at a second end of the sidewall opposite the base wall and tightly closing the capsule, the lid being removably attached to the flange for use of the capsule in a beverage preparation device,
a filter element positioned in the inner space of the capsule between the beverage ingredient and the lid, and
a carrier disk comprising outlet openings obtained by a method as described above, wherein the carrier disk is provided in the inner space of the capsule,
wherein the carrier disk is positioned in the inner space of the capsule between the lid and the filter; and
wherein the carrier disk comprises between 50 and 150 outlet openings and the open surface ratio of the carrier disk is higher than 4%.

Considering that the capsule is to be extracted in a beverage preparation device comprising an extraction plate with tearing surfaces, the outlet openings may be distributed over the carrier disk homogeneously with less than 10% of the outlet openings of the carrier disk directly facing the tearing surfaces of the extraction plate. This feature allows that the extracted coffee is not prevented from going out of the carrier disk and affected by the nearby tearing surface of the extraction plate.

Furthermore, the pattern of the outlet openings distribution over the carrier disk may be constructed in such a way that the outlet openings distribution is not depending on the angular positioning of the carrier disk with regards to the tearing surface of the extraction plate.

The lid of the capsule may comprise a free pull tab protruding from the lid. The pull tab may be integral with the lid allowing to remove the full lid. This handling and opening are then easier.

In an embodiment, the lid comprises at least an aluminum layer to ensure a better shelf life of the coffee in the capsule.

In addition, the lid may further comprise a plastic layer and/or a heat seal layer to ensure food grade compatibility for sealing the lid onto the flange of the capsule.

As a preference, the capsule body, the lid, and the carrier disk are each mainly made from aluminum. The use of aluminum ensures a better coffee protection and a longer shelf life. Additionally, the end of life of the capsule is easier and recycling is easier.

In an alternative way, the capsule body, the lid and the carrier disk may each be made of plastic or of a laminated or multilayer plastic element.

The beverage ingredient is preferably ground coffee, preferably in an amount of at least 4 g, preferably between 4.5 g and 15 g.

Thanks to the proposed capsule construction, the carrier disk may be positioned inside the capsule and kept at distance from the lid comprised, e.g. at a distance between 0.1 mm and 2 mm. This allows avoiding possible interaction between the carrier disk and the tearing surface of the extraction plate of the beverage preparation device when the coffee bed volume expands during extraction.

The capsule may be designed to sustain an extraction of the beverage ingredient in an extraction process made at a pressure below 8 bar, more preferably below 5 bar.

The invention also provides a system as described herein.

The system of the invention aims at preparing a beverage. It comprises an exchangeable capsule, such as a capsule as described above, and a beverage preparation device with a fluid dispensing device capable of feeding an amount of a fluid, such as water, with a pressure between 0.1 bar and 20 bar to the capsule, and with a brewing chamber, comprising a first part for holding the capsule and a second part for closing the brew chamber.

The system proposes to use the exchangeable capsule integrating one or more of the above disclosed features in the beverage preparation device where the second part of the brewing chamber of the beverage preparation device comprises an extraction plate for engaging with the exchangeable capsule at the second end of the sidewall when the brew chamber holding the capsule is closed, the extraction plate comprising a tearing surface facing, in use, the carrier disk at the second end of the capsule, wherein the carrier disk of the capsule in use in the closed brewing chamber is not altered by the tearing surface of the extraction plate and wherein in use, less than 10% of the outlet openings are directly facing the tearing surface of the extraction plate.

More specifically, the tearing surface of the extraction plate may comprise pyramidal elements, and according to the outlet openings distribution less than 10% of the outlet openings are directly facing the pyramidal elements of the tearing surface.

Advantageously, the outlet openings distribution over the carrier disk is also constructed in such a way that the outlet openings distribution is not depending on the angular positioning of the carrier disk with regards to the tearing surface of the extraction plate.

The extraction of the beverage ingredient may be an extraction made at a pressure below 8 bar, more preferably below 5 bar.

The invention is further directed to the use of the capsule presenting one or more of the above disclosed features alone or in a system presenting one or more of the above disclosed features.

The disclosure of European patent application n°20210284.4-filed on 27 Nov. 2020 is here incorporated by reference.

Specific embodiments of the invention are described in the following detailed description. The objects are achieved by the present invention, i.e. a capsule, a system and a capsule manufacturing method.

### BRIEF DESCRIPTION OF THE DRAWINGS

The invention is further described with reference to the following examples and drawings, which form part of the present invention. The drawings are not in any way meant to reflect a limitation of the scope of the invention, unless this is clearly and explicitly indicated. It will be appreciated that the invention as claimed is not intended to be limited in any way by these exemplary embodiments and illustrations.

It is noted that the figures are only schematic representations of embodiments of the invention that are given by way of non-limiting example.

Embodiments of the present invention will now be described, by way of examples, with reference to the accompanying figures in which:

FIG. 1a is a perspective side view of a capsule tightly closed before use in a beverage preparation device, according to the invention;

FIG. 1b is a perspective side view of a capsule in which the lid is partially removed, according to the invention;

FIG. 1c is a perspective side view of a capsule in which the lid has been removed and ready to be used in a beverage preparation device, according to the invention;

FIG. 2a is a schematic cross-sectional view of a capsule according to a first embodiment of the invention;

FIG. 2b is an enlarged view of an identified bottom portion of the capsule of FIG. 2a;

FIG. 2c is a view of the carrier disk of the capsule of FIG. 2a before being assembled in the capsule;

FIG. 3a is a schematic view of the carrier disk of the capsule of FIG. 2a once assembled in the capsule with 4 crimping points according to the first proposed embodiment;

FIG. 3b is a schematic view of the carrier disk of the capsule of FIG. 2a once assembled in the capsule with 8 crimping points according to the first proposed embodiment;

FIGS. 4a, 4b and 4c are schematic views of the carrier disk with different holes distribution patterns according to the invention;

FIG. 5 is a table presenting for different disk versions according to the invention, the dispersion's evolution over time of the creama in extracted coffee beverages;

FIG. 6a is a view of a proposed holes distribution pattern.

FIG. 6b is a transparent superposition view of the proposed holes distribution pattern of FIG. 6a with the tearing surface of the extraction plate of the beverage preparation device at three different angular position.

FIG. 7 is a schematic top view of a first set of outlet openings for a carrier disk, obtained by a method according to an embodiment.

FIG. 8 is a schematic top view of first and second sets outlet openings for a carrier disk, obtained by a method according to an embodiment.

FIG. 9 is a schematic top view of first, second and third sets of outlet openings for a carrier disk, obtained by a method according to an embodiment.

FIG. 10 is a schematic top view of first to fourth sets of outlet openings for a carrier disk, obtained by a method according to an embodiment.

FIG. 11 is a schematic top view of first to fifth sets of outlet openings for a carrier disk, obtained by a method according to an embodiment.

FIG. 12 is a schematic top view of first to sixth sets of outlet openings for a carrier disk, obtained by a method according to an embodiment.

FIG. 13 is a schematic top view of two sets of outlet openings, obtained by a cutting device cutting a sheet material by a method according to an embodiment.

FIG. 14 is a schematic top view of the two sets of outlet openings of FIG. 13 moved, or displaced, along a sheet moving direction relative to the cutting device, and of two further sets of outlet openings adjacent to the so moved sets of outlet openings and obtained by the cutting device cutting the sheet material by a method according to an embodiment.

FIG. 15 is a schematic top view of the sets of outlet openings of FIG. 14 moved, or displaced, along a sheet moving direction relative to the cutting device, and of two further sets of outlet openings adjacent to the so moved sets of outlet openings and obtained by the cutting device cutting the sheet material by a method according to an embodiment.

FIG. 16 is a schematic top view of the sets of outlet openings of FIG. 15 moved, or displaced, along a sheet moving direction relative to the cutting device, and of two further sets of outlet openings, obtained by the cutting device cutting the sheet material by a method according to an embodiment, wherein one of these sets of outlet openings (in FIG. 16: the one in the middle of the figure) is obtained relative to a part of the so moved sets of outlet openings to form outlet openings of a carrier disk.

FIG. 17 is a schematic top view of the sets of outlet openings of FIG. 16 moved, or displaced, along a sheet moving direction relative to the cutting device, and of two further sets of outlet openings, obtained by the cutting device cutting the sheet material by a method according to an embodiment, wherein one of these sets of outlet openings is obtained adjacent to the one of the sets of outlet openings obtained according to FIG. 16 in order to form outlet openings of a carrier disk.

FIG. 18 is a schematic top view of the sets of outlet openings of FIG. 17 moved, or displaced, along a sheet moving direction relative to the cutting device, and of two further sets of outlet openings, obtained by the cutting device cutting the sheet material by a method according to an embodiment, wherein one of these sets of outlet openings is obtained adjacent to the one of the sets of outlet openings obtained according to FIG. 17 in order to form outlet openings of a carrier disk.

FIG. 19 is a schematic top view of an extract of a sheet material from which a plurality of carrier disks can be obtained.

FIG. 20 is schematic side view of an exemplary production line used in a method according to an embodiment.

FIG. 21 is a schematic cross-sectional side view of a part of a cutting device in a method according to an embodiment.

FIG. 22 shows different schematic cross-sectional side views showing different phases of punching a sheet material to obtain an outlet opening, respectively, in a method according to an embodiment.

### DETAILED DESCRIPTION

As used in this specification, the words “comprise”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

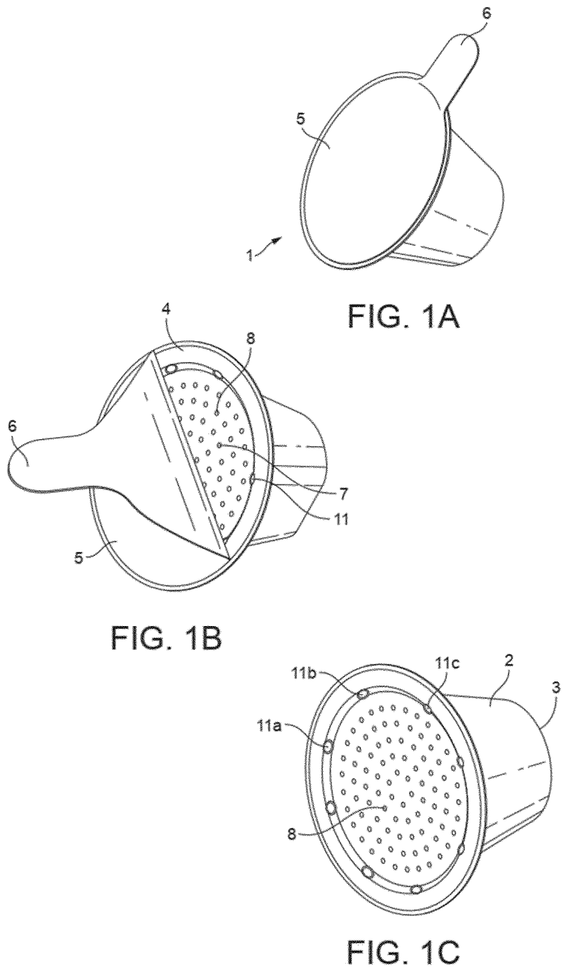

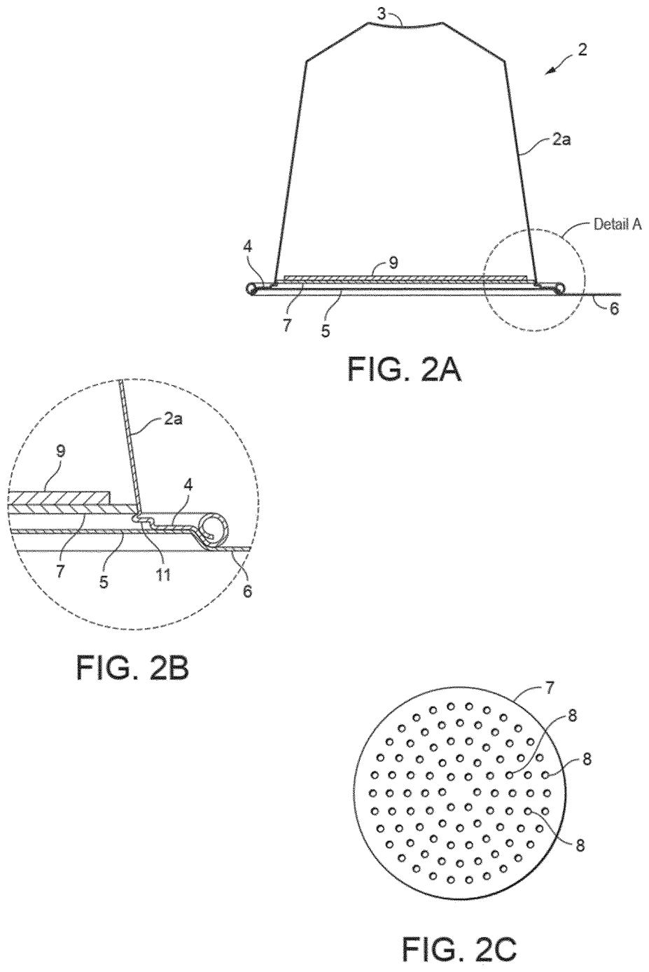

FIG. 1a shows a capsule 1 before use in a beverage preparation device, defined as storage state. Using the reference of FIG. 2, the capsule 1 of FIG. 1a, comprises a rigid capsule body 2. The body 2 comprises a frusto-conical sidewall 2a extending circumferentially around an inner space of the body. The capsule further comprises a rigid base wall 3 integral with the capsule body 2 closing off the inner space at a first end of the side wall of the capsule body 2. A flange 4 extends radially outwardly from a second end of the side wall of the capsule body 2a. At the second end of the side wall the capsule body 2 has an open filling side.

As usual, the capsule body 2 is processed to be food grade and comprises a lacquer layer or a polymer film layer (not represented) applied on the inside of the capsule body.

The capsule further includes a lid 5 that is attached to the flange 4 of the capsule body thereby closing hermetically the capsule. The lid 5 may be manually removed from the capsule by pulling on a free pull tab 6. In the present case, the pull tab 6 is integral with the lid 5 and protrudes from the lid but alternative solutions are available.

The lid 5 is a flexible sheet-like foil made of aluminum with a heat-sealing lacquer layer or a polymer layer on the sealing side.

In case the lid 5 comprises a lacquer layer on its sealing side, the thickness of the lacquer layer may be from 0.003 mm to 0.03 mm. In case the lid 5 comprises a polymer layer on the sealing side, the thickness of the polymer layer may be from 0.01 mm to 0.05 mm.

The lid 5 which is intended to be removed using the pull tab is attached to the flange 4 using an adhesive layer. The adhesive material is applied in the form of a layer of adhesive material and may be, for example, a layer of heat-seal lacquer or a polymer film layer.

As an example, the sealing layer forming the adhesive material may be a layer between 0.003 mm and 0.03 mm.

The layer of adhesive material allows removal of the lid 5 to the flange 4 of the capsule without any damage to the capsule 1.

The inner space of the capsule is filled with a beverage ingredient before the capsule is closed. In the present case, the capsule is filled with a coffee bed of roast and ground coffee before the capsule is tightly closed with the lid 5 to maintain freshness of the roast and ground coffee. The weight of the coffee is in the range of 4 g to 15 g depending on the size of the capsule. However, tea, milk or chocolate ingredients may be envisaged.

The capsule of FIG. 1b shows the capsule of FIG. 1a in which the lid 5 is partially removed by tearing the pull tab 6 and in FIG. 1c the same capsule in which the lid 5 is fully removed. As can be seen, the second end of the capsule (filling side) is no longer closed and presents on the inside of the capsule a membrane, defined as a carrier disk 7. The carrier disk 7 comprises multiple preformed outlet openings (or holes) 8 for the beverage (here coffee) prepared in the beverage preparation device. The capsule also comprises mechanical deformations 11a, 11b, 11c . . . , performed at the junction between the sidewall 2a and the flange 4 that retain the carrier disk 7 inside the inner space of the capsule. Four mechanical deformations 11 are visible in FIG. 1b. These mechanical deformations 11a, 11b, 11c . . . are also visible on the capsule of FIG. 1c, indeed eight mechanical deformations can be observed. These local deformations are made using a crimping process. Their function and the way they are done will be explained in connection with FIG. 2a and followings.

The preformed outlet openings 8 of the carrier disk 7 are covered by the lid 5 of the capsule thereby closing the capsule to keep hermetic sealing of the inner space of the capsule for ensuring freshness of the beverage ingredient inside the capsule during storage.

As will be seen in the cross-sectional views of the various embodiment of the capsule of the invention (see for example FIG. 2a), the capsule further comprises in its inner space a filter element 9 positioned between the coffee bed and the carrier disk 7. The filter element 9 prevent solid particles of the beverage ingredient, for example coffee particles or tea leaves, to flow out of the capsule inside the end-consumer cup during extraction.

The capsule body 2 and the lid 5 may be each mainly made from aluminum. However, other material may be envisaged for the capsule body and the lid.

For example, the capsule body and the lid may be made of plastic polymer material, or the capsule body and the lid may be made of paper-based material.

As is understood, the capsule is extracted using a conventional high-pressure beverage preparation device compatible with conventional Nespresso® coffee capsules. The beverage preparation device comprises a fluid dispensing device capable of feeding an amount of a fluid, such as water, with a pressure between 0.1 bar and 20 bar to the capsule, and a brewing chamber, comprising a first part for holding the capsule and a second part for closing the brew chamber, the second part of the brewing chamber comprising an extraction plate presenting a tearing surface for engaging with the capsule at its second end opposite its base wall.

Summarizing a conventional extraction process of a closed capsule in the beverage preparation device: the capsule is inserted in the brewing chamber of the beverage preparation device. The fluid dispensing device feeds an amount of a fluid, such as water, to the capsule trough the base wall 3 inside the capsule to make the coffee infused and then extracted. As pressure increases inside the capsule, the lid of the capsule comes into contact with the tearing surface of the extraction plate and the lid is altered by said tearing surface leading to the formation of opening which allows the coffee to flow out of the capsule.

The formation of the outlet openings at the surface of the lid by interaction of the lid with the tearing surface for the flow out of the coffee participates to the formation of foam and cream in the preparation process.

The use of conventional capsule (closed capsule) with the above-mentioned process leads to a coffee extraction at a pressure between 8 bar and 20 bar.

In the extraction process of a capsule, the lid of the capsule is removed before insertion of the capsule inside the brewing chamber of the beverage preparation device. The fluid dispensing device feeds an amount of a fluid, such as water, to the capsule through the base wall 3 inside the capsule to make the coffee infused and then extracted. The extracted coffee goes through the filter element 9 and then flows out through the outlet openings of the carrier disk 7. During extraction, the carrier disk 7 (which is at a distance from the flange of the capsule) is not intended to come into contact with the tearing surface of the extraction plate of the beverage preparation device. The carrier disk 7 is not altered by the tearing during extraction of the capsule (as it is the case of a conventional extraction of a closed capsule where the capsule membrane is teared on the tearing surface of the extraction plate, as explained in the previous section

The use of a capsule (in a conventional beverage preparation device) leads to a coffee extraction at a pressure between 0.1 bar and 8 bar, depending on the quantity of coffee inside the capsule and on the filter element structure.

Due to the fact that the lid is removed from the capsule before its use in the beverage preparation device and as the carrier disk is located inside the capsule (see FIG. 2a for example), the carrier is not intended to come into contact with the tearing surface of the extraction plate and is thus not deformed by said tearing surface.

In more details, when preparing a coffee using a capsule 1 in a beverage preparation device, the user removes the lid 5 by tearing on the pull tab 6 before inserting the capsule in a beverage preparation machine. The base wall 3 of the capsule body 2 is further pierced and opened by piercing means of a beverage preparation device for supplying water under pressure into the capsule for the preparation of a coffee beverage.

Due to the fact that the capsule is not closed (lid 5 removed and outlet openings accessible) when used in the beverage preparation device, the extraction pressure building up inside the capsule is limited (0.1 to 6 bar) and there is limited formation of foam and cream during extraction.

Hence, because the pressure built up and the sudden pressure drop are not occurring (as with the use of conventional capsule) at the interaction between the coffee/the lid/the opening element(s) with the tearing surface of the extraction plate of the beverage preparation device, the resulting coffee in cup is with little or no crema.

The capsule allows preparing crema-free coffee, tea, milk or chocolate depending on the beverage ingredient inside the capsule.

FIG. 2a shows a first embodiment of the capsule. As disclosed, the capsule comprises inside the inner space a carrier disk 7 comprising multiple preformed outlet openings 8 (i.e. a perforated carrier disk).

As presented on FIG. 2b, which is an enlarged and cross-sectional view of the identified bottom part portion of FIG. 2a, the carrier disk 7 is positioned inside the capsule at a distance from the lid 5 comprised between 0.1 mm to 2 mm, the lid 5 being sealed on the flange 4.

This gap between the capsule lid 5 (and so the flange 4 once the lid is removed for extraction) and the carrier disk 7 provides a recess so that if the carrier disk 7 flexes during the extraction process it does not come into tearing interface with the tearing surface of the extraction plate of the beverage preparation device.

The carrier disk 7 may be a substantially round piece of material as shown in FIG. 2c, and its diameter is approximately the inner diameter of capsule at the location where the carrier disk 7 is positioned/inserted/maintained depending on the assembling process.

Hence, in the proposed embodiment, the diameter of the carrier disk 7 may be around 29.5 and 30.5 mm.

In the proposed embodiment, the carrier disk may be made of Aluminum. Its thickness may be about 0.3 mm but may vary between 0.1 mm and 1 mm.

The carrier disk may be made of aluminum and in a preferred solution, as the one presented in the figures, the capsule body, the lid, and the carrier disk are each mainly made from aluminum.

In the presented solution, the carrier disk 7 is maintained inside the capsule thanks to local mechanical deformations 11 made on the capsule at the junction between the side wall 2a and the flange 4 of the capsule 1. In the detailed cross section of FIG. 2b, one mechanical deformation 11 is visible. The mechanical deformation is in the form of a crimping point 11 and is located on the side of the open side of the capsule, opposite the base wall 3.

As the capsule is made of a ductile material, preferably aluminum, the mechanical deformation by crimping allows reducing locally the diameter and thereby holding the carrier disk 7 (and filter) inside the capsule. The carrier disk is then retained inside the capsule 1.

Here, during the manufacturing process, the step of mechanically deforming the capsule at the junction of the flange 4 and sidewall 2a leading to the crimping points 11 is made on the capsule before closing the capsule with the lid 5.

The crimping points 11 (also visible on FIG. 1c), which are between 2 and 10 crimping points are angularly distributed on the perimeter of the open side of the capsule at the junction of the flange and sidewall of the capsule.

In view of the tooling that is used to make the crimping points, the crimping points 11 will preferably be equally distributed on the perimeter of the open side of the capsule.

Additionally, the crimping points 11 may have rounded crimping imprints according to the used crimping tool.

In an alternative way, the carrier disk 7 may be made of plastic or of a laminated membrane comprising for example, in polyolefins such as polypropylene, polyethylene or any other semi crystalline polymer. The carrier disk 7 may also be made of paper-based material, like a coated paper, a laminated paper or molded paper.

As can be seen on the FIG. 2c, the preformed outlet openings 8 may be circular openings homogeneously distributed on the surface of the carrier disk. This homogeneous distribution of the outlet openings with ensure a homogeneous flux of the coffee flowing out of the capsule 1. This also helps to avoid creation of channel with the beverage (coffee bed) inside the capsule.

The openings may have a diameter set around 0.75 mm to 1 mm, but the diameter may vary between 0.4 mm and 3 mm, most preferably between 0.5 mm and 1.3 mm.

The number of preformed outlet openings may vary depending on the size of the capsule (and on the size of the carrier disk) and on how fast the delivery of coffee is wished. In the disclosed embodiment, the carrier disk 7 comprises between 50 and 150 openings, preferably around 90 and in the presented embodiment around 100 outlet openings.

In an alternative embodiment, the preformed outlet openings may be of oblong shape.

As presented, the capsule may further comprise a filter element 9 that during a possible assembling process is positioned on the ingredient bed (coffee bed for example) after the filling of the capsule, and the carrier disk 7 is positioned between the filter element and the lid 5. In an alternative assembling process, the filter is assembled onto the carrier disk and both elements are inserted into the capsule over the ingredient bed.

When the capsule is turned up-side down and as presented in the enlarged view of FIG. 2b, the filter element 9 lies on the carrier disk 7. The filter element is then supported by the carrier disk 7 inside the capsule. The filter is maintained flat inside the capsule and is not contacted by the tearing surface of the extraction plate of the beverage preparation device during extraction.

The use of a two-piece design may enable the use of none-sealable filter materials which could be an advantage for sustainability.

As proposed in this embodiment, the filter element 9 is circular with a smaller diameter than the diameter of the carrier disk 7, i.e. between 28 mm and 30.5 mm, and in general with 0.1 mmn less than the disk carrier.

However, in an alternative embodiment, the diameter of the filter element 9 could be similar to the one of the carrier disk 7.

The filter element 9 may be made of non-woven material adapted to prevent/refrain coffee drains to go through too slowly or too quickly during extraction of the beverage with the aim to avoid creation of a crema layer and with the aim to avoid coffee drain going directly through the disk carrier to the cup.

The filter element 9 of the proposed embodiment may comprise a thickness between 20 to 300 microns, an air permeability in the range of 100 to 5000 l/m²/s according to ISO 9237, and a weight in the range of 5 to 600 g/m². It may for example be a paper-based filter element.

The filter elements may comprise a layer of non-woven material connected by any known means to another filtering layer.

In the proposed embodiment of FIGS. 2a to 2c, the filter element 9 and carrier disk 7 are independent elements positioned on one another. However, they may be assembled together, for example by gluing or any other means. This will then change the assembling process in the capsule as the insertion of the filter and carrier disk will be made in one step. The filter element 9 and the carrier disk 7 may form together one part.

The proposed circular carrier disk 7 may have a tapered shape on its perimeter so as to fit (force fit) into capsules having truncated cone shape. However, other alternative shape and arrangement of the carrier disk inside the capsule may be envisaged.

It is preferred that the carrier disk 7 and filter element 9 remain in place inside the capsule when the lid 5 is removed and the capsule 1 extracted in the beverage preparation machine. Several assembling process may be considered and will be later on disclosed in connection with the proposed embodiments of the capsule.

In a variant embodiment that is not represented, the carrier disk may be made of plastic or of a laminated plastic element. In this situation, the assembling process of the carrier disk in the capsule would remain similar.

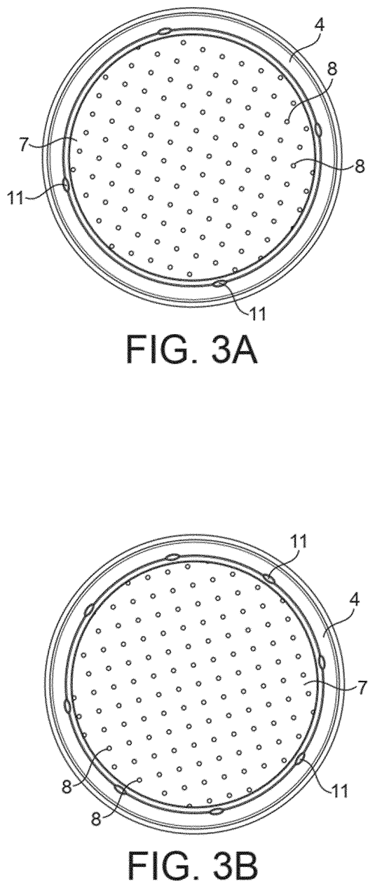

FIGS. 3a and 3b are representing the capsule of FIG. 2a (view from the open side of the capsule) with a carrier disk 7 inserted into the capsule of FIG. 2a once assembled in the capsule with, respectively, 4 and 8 crimping points before closing the open side of the capsule by attaching a lid. As can be seen, the holes distribution pattern of the carrier disk 7 is the same but viewed at two different angular positions.

The number of crimping points (mechanical deformation) may vary between 2 and 10 to allow sufficient and efficient retention of the carrier disk 7 (and filter element 9 supported by the carrier disk) inside the capsule 1.

The crimping points 11 are angularly distributed around the open side perimeter of the capsule at the junction between the sidewall 2a and the flange 4 of the capsule. Preferably as here presented the crimping points are equally distributed along the perimeter of the open side of the capsule.

The currently used tooling during the step of mechanically deforming the capsule has a round end shape allowing to have crimping points with substantially rounded crimping imprints.

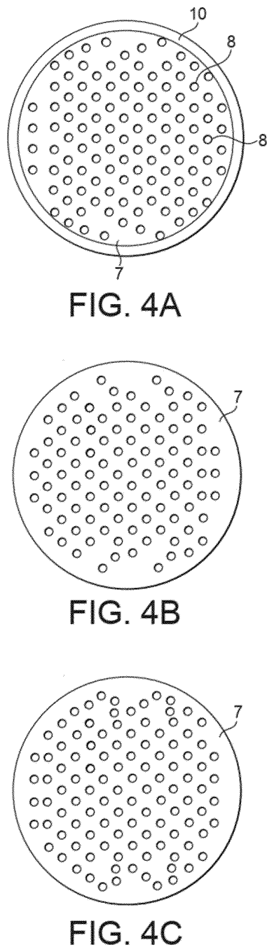

FIGS. 4a, 4b and 4c are presenting different satisfactory versions of the carrier disk 7 to be inserted in the inner space of the capsule body 2, with different holes distribution. As already seen in the previous figures, the carrier disk 7 comprises multiple preformed outlet openings 8 suitable for draining the prepared beverage from the inner space of the capsule towards the outside of the capsule when the capsule is used in the beverage preparation device.

The carrier disk 7 may be an aluminum disk of preferably circular shape with a diameter that may be set at 30 mm+/−3 mm. However, the diameter of the carrier disk may be comprised between 28.5 mm and 30.5 mm depending on the size and/or the construction of the capsule.

The thickness of the carrier disk 7 that is used in the capsule of FIG. 2a may be around 0.3 mm. However, the thickness of the carrier disk may vary. It can be comprised between 0.05 mm and 1.5 mm, preferably between 0.1 mm and 1 mm, most preferably between 0.2 mm and 0.8 mm.

The carrier disk may have a void-space 10 that is void of outlet openings on its external perimeter over a distance of at least 0.5 mm in order to avoid that during assembling some outlet openings are damaged and/or are overlapped by the crimping points (visible in FIGS. 3a and 3b). The void-space 10 is particularly visible in FIG. 4a.

As shown on the figures, the outlet openings 8 are preformed calibrated circular openings. The outlet openings 8 are preferably homogeneously distributed on the surface of the carrier disk 7 and each outlet opening may spaced apart from adjacent outlet opening(s) of a distance of 2.5 mm however, this distance may be comprised between 0.5 mm and 3 mm. The pattern of the openings distribution may look like a grid or a matrix.

In the proposed embodiments, the outlet openings 8 may have a diameter that is set around 1 mm. However, the outlet openings may have a diameter comprised between 0.4 mm and 3 mm, preferably between 0.5 mm and 1.3 mm.

In a variant embodiment which is not represented, the outlet openings are oblong holes.

The manufacturing process of the carrier disk with the specific outlet openings distribution may be done using a punching technology of metallic foils. This type of technology uses a die to punch the material through a matrix. However, other technologies known to the skilled person may be used.

The proposed carrier disks 7 of FIGS. 4a, 4b and 4c may comprise between 50 and 150 outlet openings 8 with an open surface ratio of the carrier disk preferably higher than 4%.

The open surface ratio is defined as being the ratio between the sum of the hole's surfaces over the surface of the carrier disk. The formula is the following:

$${R}_{os} = \frac{\sum Sh}{Sd}$$

Ros=open surface ratio
Sh=hole surface
Sd=carrier disk surface

In the present innovation, the initial requirement is to obtain through extraction of a single-use capsule in a conventional Nespresso® machine, a filter-like coffee with as little crema as possible. If in some case some crema is generated, it is expected that this crema disappears after 2 minutes.

The below table (table 1) shows that, not only the number of outlet openings 8 (also called holes) is important but also the size of the holes and the size of the carrier disk, leading to the open surface ratio.

Tests have been performed with on a carrier disk with a diameter of approximately 30 mm.

The data presented in table 1 show the following.

Tests 1, 2 and 5 to 7 were done with a number of holes higher than 50 and with an open surface ratio higher than 4%. The results were considered satisfactory as the resulting coffee beverages did not show any remaining crema after 2 mins from the extraction.

In test 3, when the number of holes is below 50 and the open surface ratio is lower than 4%, the extracted coffee comprises crema that does not disappear after 2 mins. The final extracted coffee was similar to a coffee obtained from the high-pressure extraction of a closed capsule.

In test 4, when the number of holes is below 50, 2 for instance, and the open surface ratio higher than 4%, coffee extraction was possible but due to technical issues linked to the piercing of the filter on the tearing surface of the machine, coffee was not satisfactory with coffee grain in the cup. The extraction process was similar to the conventional high pressure closed capsule extraction with tearing of a capsule element (here the filter) on the tearing surface of the beverage machine's extraction plate.

TABLE 1

| | | Holes | Open | |
|---|---|---|---|---|
| | Number | diameter | surface | Results 2 mins |
| Test | of holes | (mm) | ratio | after extraction |
| 1 | 98 | 0.93 | 9.5% | No remaining crema |
| 2 | 112 | 0.93 | 10.9% | No remaining crema |
| 3 | 42 | 0.93 | 3.9% | Some crema is remaining |
| 4 | 2 | 5 | 5.6% | Piercing of the filter/carrier |
| | | | | disk on the pyramid plate of |
| | | | | the machine - extraction |
| | | | | similar convention high |
| | | | | pressure closed capsule |
| | | | | extraction |
| 5 | 90 | 0.8 | 5.5% | No remaining crema |
| 6 | 95 | 0.9 | 8.7% | No remaining crema |
| 7 | 69 | 0.9 | 6.3% | No remaining crema |

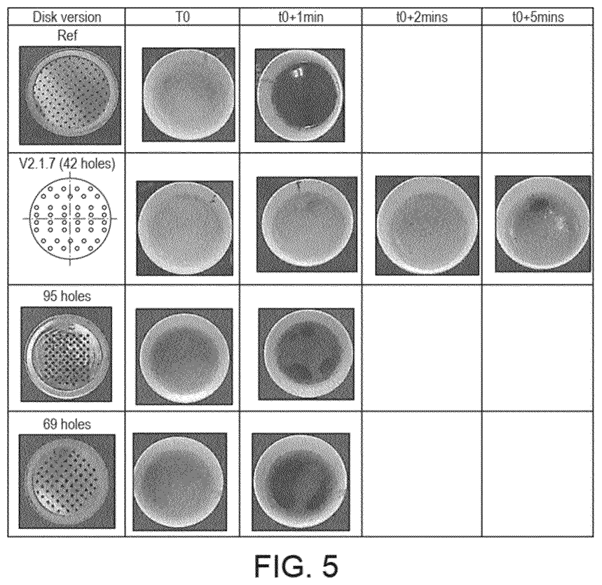

Referring to FIG. 5, a table is presented showing, for different carrier disk versions and the resulting extracted coffee (picture of the coffee cup from above), at different time, t0 corresponding to the end of the extraction, t0+1 min corresponding to 1 min after the end of extraction, t0+2 min corresponding to 2 mins after the end of extraction, and t0+5 mins corresponding to 5 mins after the end of extraction.

As can be seen, the carrier disks corresponding to the reference and to the carrier disks having more 50 holes show no crema or very little crema remaining in the cup at t0+1 min.

The carrier disk (V2.1.7) comprising 42 holes shows remaining crema in the coffee at t0+5 mins and therefore does not correspond to the expected filter-like coffee. This carrier disk can therefore not be retained for the specific purpose of producing a filter-like coffee using a single-use capsule in a conventional Nespresso® machine.

From the above results (FIG. 5 and table 1), the carrier disk preferably comprises between 70 and 120 outlet openings, and most preferably comprises between 85 and 110 outlet openings.

As for the open surface ratio of the carrier disk, the open surface ration may be higher than 4% and is preferably comprised between 4% and 15%, more preferably between 5 and 12%.

For example, for openings having a diameter of 0.3 mm homogeneously distributed on a carrier disk having a diameter of approximately 30 mm.
An open surface ratio of 5% lead to approximately 200 holes,
An open surface ratio of 10% lead to approximately 995 holes.
An open surface ratio of 15% lead to approximately 1493 holes.

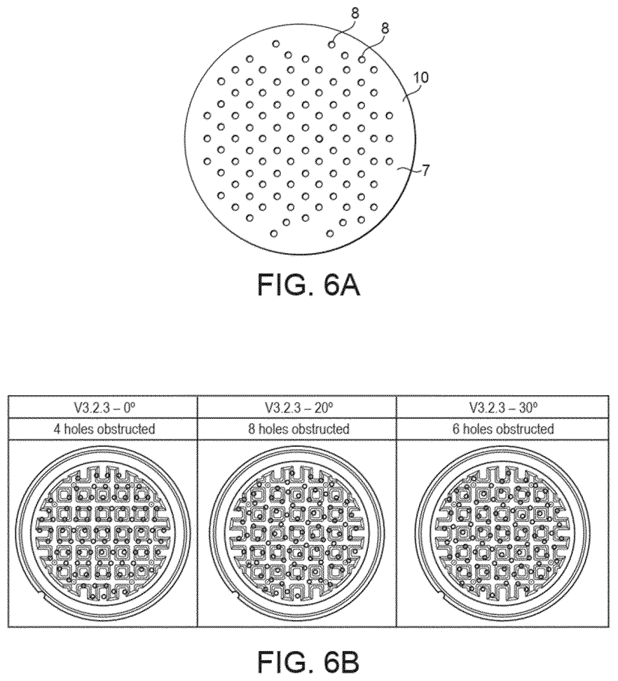

Turning to FIGS. 6a and 6b, a proposed carrier disk 7 and different orientation of this carrier disk with regards to tearing surfaces 12 of an extraction chamber of a beverage preparation device.

The presented carrier disk 7 may have an approximate diameter of 30 mm and comprises 96 outlet openings distributed all over the surface of the carrier disk, with the exception of void-space 10 that is void of outlet openings 8 on its external perimeter over a distance of approximately 1 mm.

The open surface ratio of the carrier disk is around 9.3%.

In addition to the above discussed parameters, and as explained, the capsule 1 integrating said specific carrier disk 7 is intended to be extracted in a beverage preparation device or machine (not represented).

The beverage preparation device which is not represented comprises a fluid dispensing device capable of feeding an amount of a fluid, such as water, with a pressure between 0.1 bar and 20 bar to the capsule, and a brewing chamber, comprising a first part for holding the capsule and a second part for closing the brew chamber. The second part of the brewing chamber comprises an extraction plate for engaging with the exchangeable capsule at the second end of the sidewall when the brew chamber holding the capsule is closed, the extraction plate comprising a tearing surface with pyramidal elements facing, in use, the second end of the capsule.

Hence during the extraction process of the capsule of the invention, the lid of the capsule is removed before insertion of the capsule inside the brewing chamber of the beverage preparation device. The capsule and more specifically the carrier disk 7 is then facing the tearing surface (in the form of pyramid elements) of the extraction plate of the beverage preparation device.

During the extraction process, the water is injected in the capsule and mixes with the coffee ingredient disposed in the inner space of the capsule. As the lid has been removed, the extraction of the coffee ingredient is an extraction at a pressure below 8 bars, more preferably below 5 bars.

The coffee beverage then goes through the filter and aims at flowing out of the capsule through the outlet openings.

Even if, during extraction, the carrier disk does not come into a tearing interaction with the tearing surface of the extraction plate, it is important that the extracted coffee is not prevented from going out of the carrier disk and affected by the nearby tearing surface of the extraction plate.

In the proposed pattern of outlet opening's distribution, less than 10% of the outlet openings 8 of the carrier disk 7 are directly facing the tearing surfaces of the extraction plate.

The pattern is constructed in such a way that the above feature is not depending on the angular positioning of the carrier disk with regards to the tearing surface of the extraction plate.

FIG. 6b specifically shows a transparent superposition of the carrier disk and tearing surface of the extraction plate presenting the proposed holes distribution pattern of FIG. 6a at three different angular position, respectively 0°, 20° and 30°.

For each angular position of the carrier disk 7 the number of obstructed holes has been counted: 4 holes obstructed at 0°, 8 holes obstructed at 20° and 6 holes obstructed at 30°.

Thanks to the low number of holes obstructed (less than 10%) whatever the angular position of the carrier disk with regards to the tearing surface of the extraction plate, an optimized and regular flow of extracted coffee is obtained.

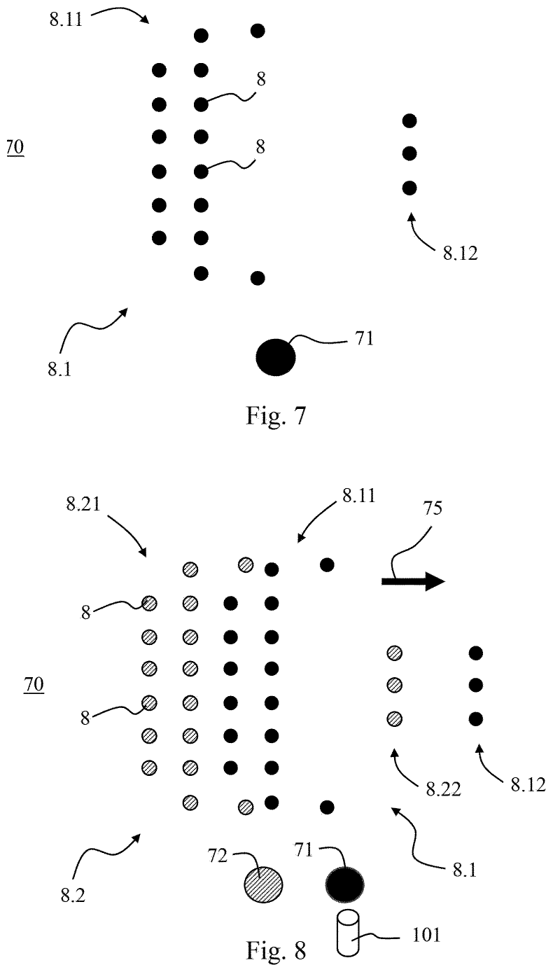

As explained above, the number of openings 8 of the carrier disk 7 and the diameter of each of these openings 8 is important to achieve no remaining crema or at least a particularly low amount of crema in the resulting beverage. It is thus desired to produce a particularly high number of these openings 8 in a carrier 7 with high accuracy, i.e. in a precise manner. The following embodiment of a method explained with reference to FIGS. 7 to 22 achieves this objective in a very easy manner.

FIG. 7 shows a sheet material 70 from which the carrier disk 7 with the outlet openings 8 can be obtained. As shown, a cutting device (not shown) has cut the sheet material to obtain a first set 8.1 of the outlet openings 8. The first set 8.1 is indicated in black. As shown, the outlet openings of the first set 8.1 may be non-homogenously distributed, e.g. in such a way that the first set 8.1 comprises at least a first sub-set 8.11 of outlet openings and a second sub-set 8.12 of outlet openings, wherein the sub-sets 8.11 and 8.12 may be distanced from one another with a distance that is greater than a distance between adjacent outlet openings of the same sub-set. For example, in each of the sub-sets 8.11 and 8.12, the respective outlet openings may be homogenously distributed. In other words, the non-homogenous distribution of the outlet openings of the first set 8.1 may be effected by the distance between the sub-sets 8.11 and 8.12. The outlet openings in the first set 8.1 may be arranged according to a matrix or a grid, such as along a plurality of columns and a plurality of rows.

As shown in FIG. 7, the sheet material 70 comprises a (first) alignment opening 71. In this embodiment, the alignment opening 71 has been cut by the cutting device. For example, by cutting the sheet material 70 to obtain the first set 8.1, the cutting device at the same time cuts the sheet material 70 to obtain the alignment opening 71. In alternative embodiments, the alignment opening 71 may be prefabricated in the sheet material 70 so that there is no need for the cutting device to produce the alignment opening 71. The alignment opening 71 is not limited to a specific shape. For example, the alignment opening 71 has a circular shape and/or has a diameter greater than the diameter of each of the outlet openings 8.

FIG. 8 shows the sheet material 70 with a second set 8.2 of the outlet openings 8. The second set 8.2 is indicated by a diagonal hatching. After the sheet material 70 has been cut to obtain the first set 8.1, as shown in FIG. 7, the sheet material 70 and thus the first set 8.1 may be moved along a defined distance in the direction 75 relative to the cutting device and then stopped. That is, the sheet material 70 may be moved intermittently. Then, in the step of aligning, an alignment element 101 (e.g. in the form of a pin), which may be part of the cutting device, is moved to extend through the first alignment opening 71. Thereby, the first set 8.1 is precisely aligned (centered, positioned, etc.) relative to the cutting device. In an optional step preceding the aligning by the alignment opening 71, a pre-aligning of the alignment opening 71 relative to the alignment element 101 may be carried out. For example, an optical device may (automatically) measure a distance between the alignment opening 71 and the alignment element 101, whereupon the sheet material 70 is advanced along this distance so that the alignment opening 71 is approximately flush with the alignment element 101. In other words, the pre-alignment of the sheet material with respect to the alignment element may be made by (automatic) visual control.

After the step of aligning, the cutting device cuts the sheet material 70 to obtain the second set 8.2. As shown, at least part of the second set 8.2 may be adjacent to the first set 8.1 preferably such that at least part of the outlet openings of the first set 8.1 and at least part of the outlet openings of the second set 8.2 form a set of outlet openings that are homogenously distributed. As shown, the second set 8.2 may have a hole pattern identical to the first set 8.1. Hence, the second set 8.2 may also comprises at least a first sub-set 8.21 of outlet openings and a second sub-set 8.22 of outlet openings, wherein the sub-sets 8.21 and 8.22 may be distanced from one another. As shown, the second sub-set 8.22 may be arranged between the sub-sets 8.11 and 8.12 of the first set 8.1.

As shown in FIG. 8, the sheet material 70 may comprises a second alignment opening 72. The second alignment opening 72 may have been cut by the cutting device. For example, by cutting the sheet material 70 to obtain the second set 8.2, the cutting device at the same time cuts the sheet material 70 to obtain the second alignment opening 72. In alternative embodiments, the alignment opening 72 may be prefabricated in the sheet material 70 so that there is no need for the cutting device to produce the alignment opening 72. The alignment opening 72 may be identical to the alignment opening 71. The alignment opening 72 is not limited to a specific shape. For example, the alignment opening 72 has a circular shape and/or has a diameter greater than the diameter of each of the outlet openings 8.

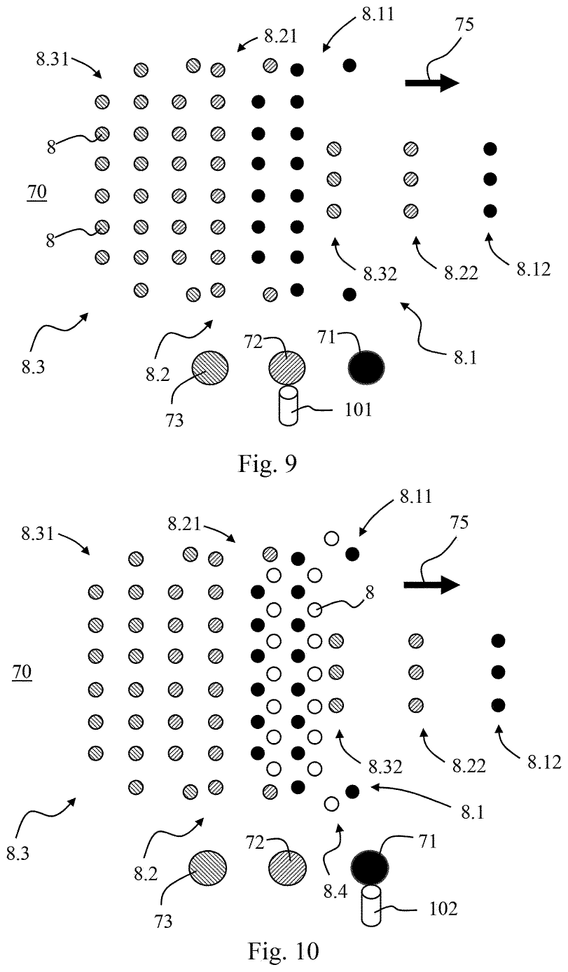

FIG. 9 shows the sheet material 70 with a third set 8.3 of the outlet openings 8. The third set 8.3 is indicated by a diagonal hatching that is inversed to the diagonal hatching indicating the second set 8.2. After the sheet material 70 has been cut to obtain the second set 8.2, as shown in FIG. 8, the sheet material 70 and thus the first and second sets 8.1 and 8.2 may be moved along a defined distance in the direction 75 relative to the cutting device and then stopped. Then, in the step of aligning, the alignment element 101 is moved to extend through the first alignment opening 71. Thereby, the first and second sets 8.1 and 8.2 are precisely aligned (centered, etc.) relative to the cutting device. In an optional step preceding the aligning, a pre-aligning of the alignment opening 71 relative to the alignment element 101 may be carried out, e.g. analogous to the pre-aligning of the alignment opening 71, such as by using the optical device described above.

After the step of aligning, the cutting device cuts the sheet material 70 to obtain the third set 8.3. As shown, at least part of the third set 8.3 may be adjacent to the second set 8.2 preferably such that at least part of the outlet openings of the second set 8.2 and at least part of the outlet openings of the third set 8.3 and/or of the first set 8.1 form a set of outlet openings that are homogenously distributed. As shown, the third set 8.3 may have a hole pattern identical to the hole pattern of the first and second sets 8.1 and 8.2, respectively. Hence, the third set 8.3 may also comprise at least a first sub-set 8.31 of outlet openings and a second sub-set 8.32 of outlet openings, wherein the sub-sets 8.31 and 8.32 may be distanced from one another. As shown, the second sub-set 8.32 may be arranged between the sub-sets 8.11 and 8.22.

As shown in FIG. 9, the sheet material 70 may comprises a third alignment opening 73. The third alignment opening 72 may have been cut by the cutting device. For example, by cutting the sheet material 70 to obtain the third set 8.3, the cutting device at the same time cuts the sheet material 70 to obtain the third alignment opening 73. In alternative embodiments, the alignment opening 73 may be prefabricated in the sheet material 70 so that there is no need for the cutting device to produce the alignment opening 73. The alignment opening 73 may be identical to the alignment openings 71 and 72, respectively. The alignment opening 73 is not limited to a specific shape. For example, the alignment opening 73 has a circular shape and/or has a diameter greater than the diameter of each of the outlet openings 8.

The steps described with respect to FIGS. 7 to 9 may be repeated to provide further sets of the outlet openings, in particular as follows:
moving the sheet material 70 and thus the already obtained sets along a defined distance in the direction 75 relative to the cutting device;
stopping the sheet material 70;
aligning, by the alignment element 101 moving to extend through an alignment opening (e.g. obtained in the preceding cutting step), the already obtained sets relative to the cutting device; and
cutting, by the cutting device, the sheet material 70 with the so aligned sets of outlet opening to obtain a further set of the outlet openings, including the alignment opening.

The distance, which the sheet material 70 and the first set 8.1 move relative to the cutting device in order to produce the second set 8.2 (i.e. the movement from the arrangement in FIG. 7 to the arrangement in FIG. 8), may correspond to (i.e. may equate) the distance, which the sheet material 70 and the first and second sets 8.1 and 8.2 move relative to the cutting device in order to produce the third set 8.3 (i.e. the movement from the arrangement in FIG. 8 to the arrangement in FIG. 9). In other words, for obtaining the first to third sets 8.1-8.3, the sheet material 70 may be moved relative to the cutting device intermittently along equal distances, i.e. distances that are essentially identical to one another.

FIG. 10 shows the sheet material 70 with a fourth set 8.4 of the outlet openings 8. The fourth set 8.4 is indicated in white with a black outline. After the sheet material 70 has been cut to obtain the third set 8.3, as shown in FIG. 8, the sheet material 70 and thus the sets 8.1, 8.2, 8.3 may be moved along a defined distance in the direction 75 relative to the cutting device and then stopped. Then, in the step of aligning, a further alignment element 102 (e.g., a pin or an alignment element identical to the alignment element 101) is moved to extend through the first alignment opening 71. Thereby, the sets 8.1, 8.2, 8.3 are precisely aligned (centered, etc.) relative to the cutting device. In an optional step preceding the aligning, a pre-aligning of the alignment opening 71 relative to the alignment element 102 may be carried out, e.g. analogously to the pre-aligning of the alignment opening 71 described above, such as by using an optical device as described above.

After the step of aligning, the cutting device cuts the sheet material 70 to obtain the fourth set 8.4. As shown, at least part of the fourth set 8.4 may be arranged among the outlet openings of the first set 8.1, such as of the first sub-set 8.11, preferably such that at least part of the outlet openings of the first set 8.1 and at least part of the outlet openings of the fourth set 8.4 and/or of the third set 8.3 form a set of outlet openings that are homogenously distributed. As shown, the fourth set 8.4 may be obtained between the first sub-set 8.31 and/or the first sub-set 8.21 on the one hand and the second sub-set 8.32, the second sub-set 8.22, and/or the second sub-set 8.12 on the other hand. In other words, outlet openings of the first set 8.1 may be surrounded by a section of the sheet material 70, wherein the cutting device cuts this section to obtain at least one outlet opening of the fourth set 8.4 arranged among the outlet openings of the first set 8.1. In particular, an outlet opening 8 of the fourth set 8.4 that is arranged among the outlet openings 8 of the first set 8.1 may be spaced apart from adjacent openings 8 of the first set 8.1 with a distance comprised between 0.5 mm and 3 mm and more preferably between 1 mm and 3 mm. Adjacent outlet openings 8 of the first set 8.1 may be spaced apart from one another with a distance greater than the distance between the outlet opening 8 of the fourth set 8.4, which is arranged among the outlet openings 8 of the first set 8.1, and an opening 8 of the first set 8.1, which is adjacent to said outlet opening 8 of the fourth set 8.4.

The fourth set 8.4 is not limited to a specific hole pattern. The hole pattern of the fourth set 8.4 may differ from the hole pattern of at least the first set 8.1. As shown, the outlet openings of the fourth set 8.4 may be (entirely) homogenously distributed, e.g. in such a way that the fourth set 8.4 does not comprise any sub-sets that are distanced from one another with a distance that is greater than a distance between adjacent outlet openings of the fourth set 8.4. The outlet openings in the fourth set 8.4 may be arranged according to a matrix or a grid, such as along a plurality of columns and a plurality of rows, wherein the number of rows is preferably greater than the number of columns.

The method is not limited to obtaining the fourth set 8.4 after the third set 8.3 has been obtained. For example, the fourth set 8.4 may be obtained directly after the first set 8.1 and/or the second set 8.2 has been obtained so that the fourth set 8.4 is a second set of the outlet openings or a third set of the outlet openings, respectively.

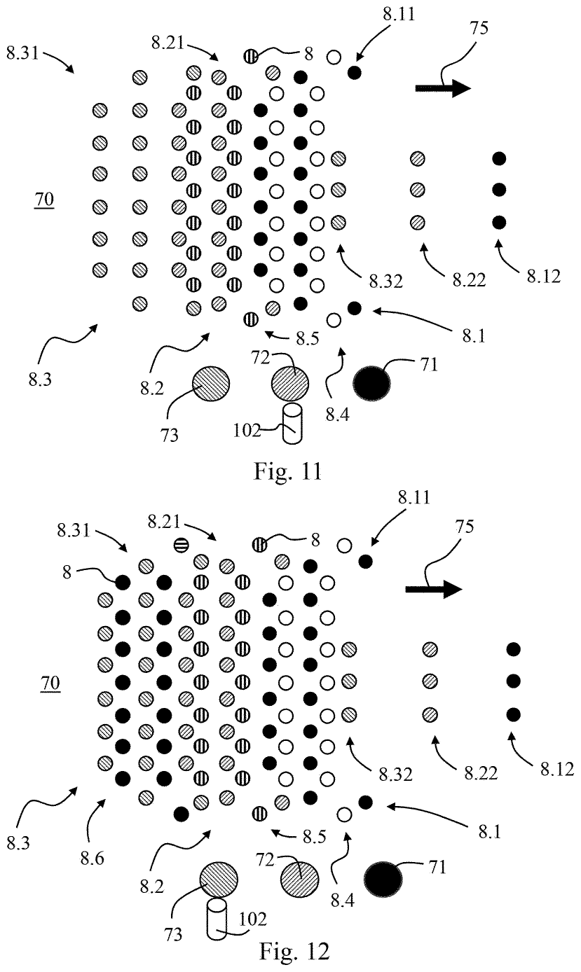

FIG. 11 shows the sheet material 70 with a fifth set 8.5 of the outlet openings 8. The fifth set 8.5 is indicated by a vertical hatching. After the sheet material 70 has been cut to obtain the fourth set 8.4, as shown in FIG. 10, the sheet material 70 and thus the sets 8.1-8.4 may be moved along a defined distance in the direction 75 relative to the cutting device and then stopped. Then, in the step of aligning, the alignment element 102 is moved to extend through the second alignment opening 72. Thereby, the sets 8.1-8.4 are precisely aligned relative to the cutting device. In an optional step preceding the aligning, a pre-aligning of the alignment opening 72 relative to the alignment element 102 may be carried out, e.g. analogously to the pre-aligning of the alignment opening 71 described above, such as by using an optical device as described above.

After the step of aligning, the cutting device cuts the sheet material 70 to obtain the fifth set 8.5. As shown, at least part of the fifth set 8.5 may be arranged among the outlet openings of the second set 8.2, such as of the first sub-set 8.21, preferably such that at least part of the outlet openings of the fifth set 8.5 and at least part of the outlet openings of the second set 8.1 and/or of the first set 8.1 form a set of outlet openings that are homogenously distributed. As shown, the fifth set 8.5 may be obtained between the first sub-set 8.31 on the one hand and the second sub-set 8.32, the second sub-set 8.22, and/or the second sub-set 8.12 on the other hand. As shown, the fifth set 8.5 may have a hole pattern identical to the fourth set 8.4. In other words, outlet openings of the second set 8.2 may be surrounded by a section of the sheet material 70, wherein the cutting device cuts this section to obtain at least one outlet opening of the fifth set 8.5 arranged among the outlet openings of the second set 8.2.

FIG. 12 shows the sheet material 70 with a sixth set 8.6 of the outlet openings 8. The sixth set 8.6 is indicated by a horizontal hatching. After the sheet material 70 has been cut to obtain the fifth set 8.5, as shown in FIG. 11, the sheet material 70 and thus the sets 8.1-8.5 may be moved along a defined distance in the direction 75 relative to the cutting device and then stopped. Then, in the step of aligning, the alignment element 102 is moved to extend through the third alignment opening 73. Thereby, the sets 8.1-8.5 are precisely aligned relative to the cutting device. In an optional step preceding the aligning, a pre-aligning of the alignment opening 73 relative to the alignment element 102 may be carried out, e.g. analogously to the pre-aligning of the alignment opening 71 described above, such as by using an optical device as described above.

After the step of aligning, the cutting device cuts the sheet material 70 to obtain the sixth set 8.6. As shown, at least part of the sixth set 8.6 may be arranged among the outlet openings of the third set 8.3, such as of the first sub-set 8.31, preferably such that at least part of the outlet openings of the fifth set 8.5 and at least part of the outlet openings of the third set 8.3 and/or of the second set 8.2 form a set of outlet openings that are homogenously distributed. As shown, the sixth set 8.6 may be obtained between part of the first sub-set 8.31 on the one hand and the second sub-set 8.32, the second sub-set 8.22, and/or the second sub-set 8.12 on the other hand. In other words, the outlet openings of the third set 8.3 may be surrounded by a section of the sheet material 70, wherein the cutting device cuts this section to obtain at least one outlet opening of the sixth set 8.6 arranged among the outlet openings of the third set 8.3

As shown, the sixth set 8.6 may have a hole pattern identical to the fourth set 8.4 and/or fifth set 8.5.

The steps described with respect to FIGS. 10 to 12 may be repeated to provide further sets of the outlet openings, in particular as follows:
moving the sheet material 70 and thus the already obtained sets along a defined distance in the direction 75 relative to the cutting device;
stopping the sheet material 70;
aligning, by the alignment element 102 moving to extend through an alignment opening (e.g. obtained in one of the cutting steps to obtain the first to third sets), the already obtained sets relative to the cutting device; and
cutting, by the cutting device, the sheet material 70 with the so aligned sets of outlet opening to obtain a further set of the outlet openings.

The distance, which the sheet material 70 and the fourth set 8.4 move relative to the cutting device in order to produce the fifth set 8.5 (i.e. the movement from the arrangement in FIG. 10 to the arrangement in FIG. 11), may correspond to (i.e. may equate) the distance, which the sheet material 70 with the fourth and fifth sets 8.4 and 8.5 move relative to the cutting device in order to produce the sixth set 8.6 (i.e. the movement from the arrangement in FIG. 11 to the arrangement in FIG. 12). In other words, for obtaining the fourth to sixth sets 8.4-8.6, the sheet material 70 may be moved relative to the cutting device intermittently along equal distances, i.e. distances that are essentially identical to one another.

To obtain the sets of the outlet openings, the sheet material 70 may be moved intermittently along different distances. For example, the (second) distance, which the sheet material 70 with the one or more sets 8.1-8.3 moves relative to the cutting device in order to produce the fourth set 8.4 (e.g. the movement from the arrangement in FIG. 9 to the arrangement in FIG. 10), may be greater than the (first) distance, along which the sheet material 70 and the first set 8.1 move relative to the cutting device in order to produce the second set 8.2 or along which the sheet material 70 with the first and second sets 8.1 and 8.2 move relative to the cutting device in order to produce the third set 8.3.

In particular, the first set 8.1 and preferably the second and third sets 8.2 and 8.3 may be obtained by using a first cutting station of the cutting device, and the fourth set 8.4 and preferably the fifth and sixth sets 8.5 and 8.6 may be obtained by using a second cutting station of the cutting device, which second cutting station is different from the first cutting station and/or distanced from the first cutting station. In particular, by moving the sheet material 70 along the second distance, the one or more sets of the outlet openings 8 obtained in the first cutting station move to the second cutting station where one or more further sets of the outlet openings 8 are obtained. Hence, the first alignment element 101 may be arranged to align (center, position, etc.) at least the first set 8.1 relative to the first cutting station, and the second alignment element 102 may be arranged to align at least the first set 8.1 relative to the second cutting station. The cutting stations may be arranged along the moving direction of the sheet material.

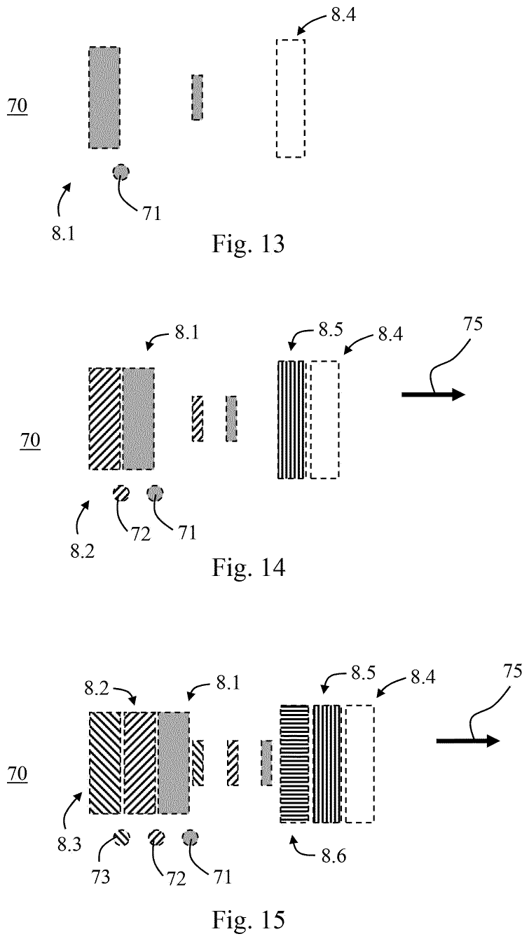

FIGS. 13 to 18 show an embodiment of the intermittent movement of the sheet material with different distances. In each interruption of this intermittent movement, at least a step of cutting (and preferably a step of aligning) is performed to obtain two respective sets of outlet openings, such as one set by the first cutting station and another set by the second cutting station, as shown in FIGS. 13 to 18, respectively. In FIGS. 13 to 18, the sets 8.1-8.6 of the outlet openings 8 are shown schematically and simplified in the form of boxes. A box corresponds to a sub-set or to a set, if the set has not a plurality of sub-sets.

As shown in FIGS. 13 to 15, the sheet material 70 is cut, by the cutting device, in particular by the first cutting station, to obtain the first to third sets 8.1-8.3, respectively, as explained above with respect to FIGS. 7 to 9, respectively. Parallel to that, the sheet material 70 is cut, by the cutting device, in particular by the second cutting station, to obtain the fourth to sixth sets 8.4-8.6, respectively. Between the states shown in FIGS. 13 and 14 and between the states shown in FIGS. 14 and 15, the sheet material 70 moves relative to the cutting device along identical distances.

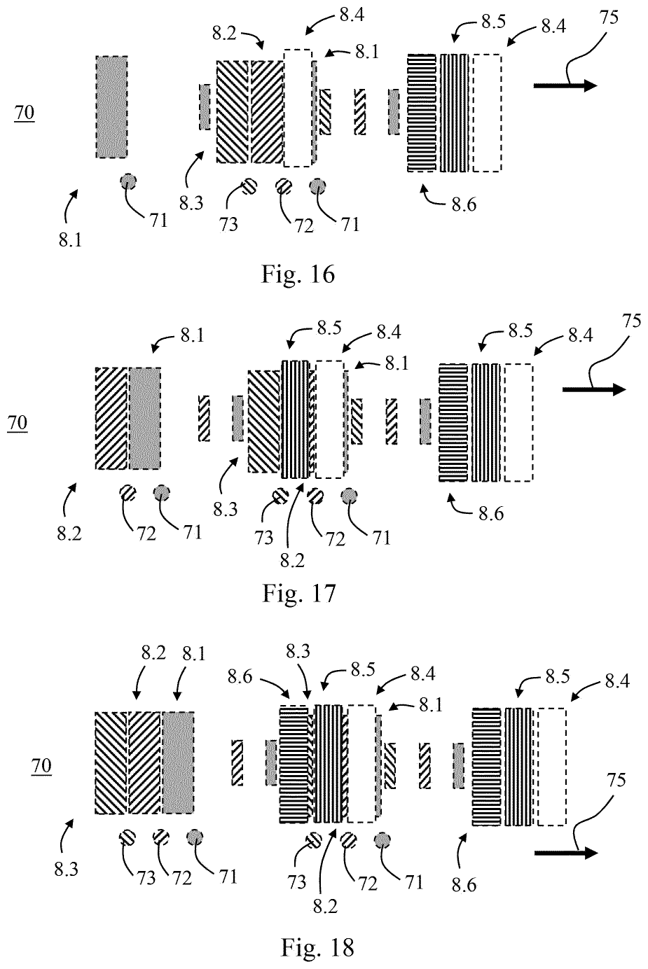

As shown in FIGS. 16 to 18, the sheet material 70 is cut, by the cutting device, in particular by the second cutting station, to obtain the fourth to sixth sets 8.4-8.6 of the outlet openings of the carrier disk 7, respectively, as explained above with respect to FIGS. 10 to 12, respectively. Parallel to that, the sheet material 70 is cut, by the cutting device, in particular by the first cutting station, to obtain further sets of outlet openings that are at least partially used for a further carrier disk 7. These further sets of outlet openings are obtained as explained above with respect to FIGS. 7 to 9, respectively. Between the states shown in FIGS. 15 and 16, the sheet material 70 and thus the first to third sets 8.1-8.3 move along a distance greater than the distance between the states shown in FIGS. 13 and 14 or between the states shown in FIGS. 14 and 15. By this greater distance, the first to third sets 8.1-8.3 are positioned relative to the second cutting station in order to obtain the fourth to sixth sets 8.4-8.6. Between the states shown in FIGS. 16 and 17 and between the states shown in FIGS. 17 and 18, the sheet material 70 moves relative to the cutting device along identical distances.

As shown in FIG. 18, at least two groups of alignment openings may be provided in a row that extends parallel to the moving direction 75 of the sheet material 70. Each group may be provided for the first and second sets of outlet openings of one or more carrier disks. Each of the groups comprises at least one respective alignment opening 71, preferably two or more respective alignment openings 71-73. In each group, the respective alignment openings 71-73 may be equidistantly arranged. The distance between adjacent groups may be different from (e.g. greater than) the distance between adjacent alignment openings in a same group.

In an optional step of the method, the carrier disk 7 comprising at least the sets 8.1-8.6 is obtained. According to an embodiment, an alignment element is used to extend through one of the one or more the alignment openings, such as through the alignment opening 71, in order to align the sets 8.1-8.6 relative to the cutting device, in particular relative to a third cutting station of the cutting device. Then, the cutting device, such as the third cutting station, cuts the sheet material 70 to obtain the carrier disk 7 in such a way that the carrier disk 7 comprises the so aligned sets 8.1-8.6 of outlet openings 8.

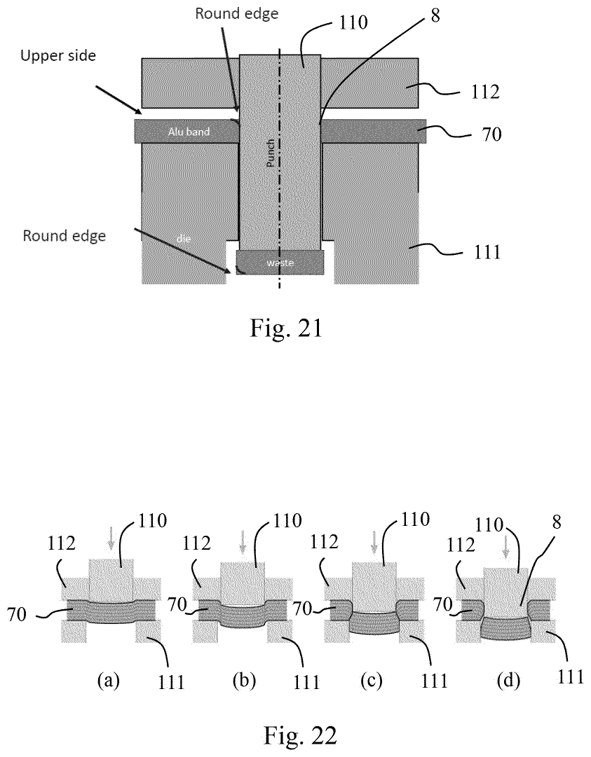

The sheet material 70 may be cut to obtain a plurality of at least two sets of outlet openings 8 for a corresponding plurality of carrier disks. Then, the so cut sheet material 70 may be brought into a state suitable for being transported, such as rolled up to form a sheet roll, such as the sheet roll 76 shown in FIG. 21. Then, the sheet roll may be provided or supplied and a plurality of carrier disks comprising the plurality of at least two sets of outlet openings 8, respectively, may be obtained from the sheet material 70. In other words, the result of the method for obtaining at least the outlet openings may be a pre-product for a plurality of carrier disks.

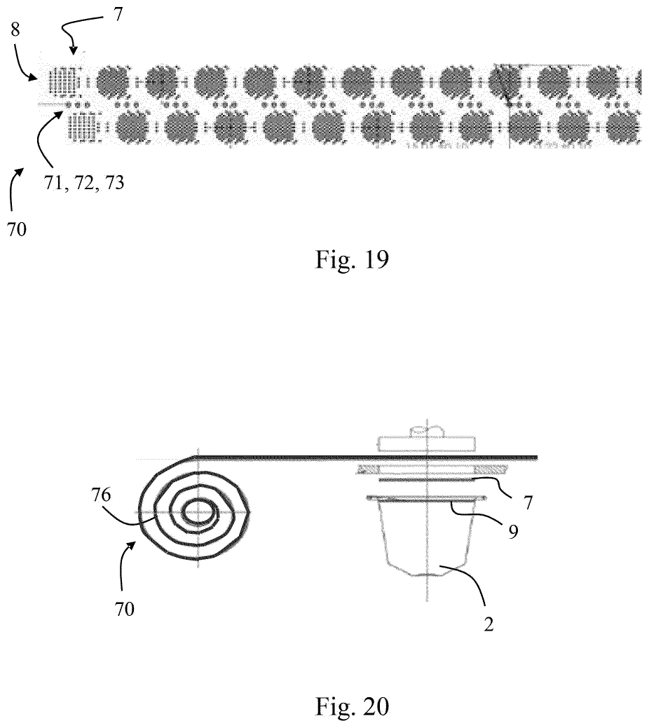

FIG. 19 shows an example of the sheet material 70. As shown, the one or more alignment openings may be arranged in a row that extends parallel to the moving direction of the sheet material. As shown, a plurality of carrier disks 8 can be produced or obtained from the sheet material 70. The plurality of carrier disks 8 can be obtained from the sheet material 70 in such a way that, after obtaining a plurality of carrier disks 8 from the sheet material 70, corresponding cut out sections are provided in the sheet material 70 according to the form of a matrix or grid, such as with a plurality of rows (e.g., at least two, preferably at least five, more preferably at least ten), wherein the rows extend parallel to the moving direction of the sheet material 70.

The sheet material 70 may comprise one or more first rows, which respectively comprise a plurality of alignment openings 71-73 and which respectively extend parallel to the moving direction of the sheet material 70, and one more second rows, which respectively comprise a plurality of sets of outlet openings for a plurality of carrier disks, respectively, and which respectively extend parallel to the moving direction of the sheet material 70. Preferably, the number of the first rows is smaller than the number of the second rows. The number of the first rows may be two. The number of the second rows may be at least 10. The plurality of alignment openings 71-73 (e.g. in each of the first rows) may be arranged in groups (for example, dependent on the number of cutting (such as punching) steps during the first production step, i.e. the step of obtaining the sets of outlet openings before obtaining, in a second production step, the carrier disks), e.g. such that each of these groups comprises at least one respective alignment opening 71, preferably two or more respective alignment openings 71-73. In each group, the respective alignment openings 71-73 may be equidistantly arranged. The distance between adjacent groups may be different from (e.g. greater than) the distance between adjacent alignment openings in a same group.

As shown in FIG. 20, the sheet material 70 may be provided as a sheet roll 76, wherein the cutting device may cut a part of the sheet material 70 that is unrolled, i.e. that is not curved but, for example, straight.

The method may further comprise the step of providing a filter element 9, such as the filter element 9 described above.

At least part of the sheet material 70 may be arranged between at least part of the cutting device and a capsule body 2 in which the carrier disk 7 and, optionally, the filter element 9 are to be positioned. For example, the sheet material unwound from the sheet roll 76 may be arranged between the cutting device and the capsule body 2 (when seen in a side view).

The method is not limited to a specific type of cutting or cutting device. The cutting device may be adapted to cut the sheet material to obtain, in a single step, a high number of outlet openings, such as 1200 outlet openings. The cutting device may comprise at least two cutting stations, wherein each of these stations may be adapted to cut the sheet material to obtain, in a single step (in a single cutting step, such as during a single stroke), at least 100 outlet openings, preferably between 200 to 400 outlet openings, In an embodiment, the cutting device is a punching device. For example, the punching device may comprise a first punching station for cutting the sheet material 70 to obtain at least the set 8.1 and a second punching station for cutting the sheet material 70 to obtain at least the set 8.4. Each of the punching stations may comprise a punch designed to obtain the hole pattern of the respective set of outlet openings. The punch may comprise a plurality of punch elements that correspond in number and arrangement to the outlet openings of the respective set of outlet openings. Each of the punching stations may comprise a die into which at least part of the punch can pass after passing through the sheet material 70. The die may comprise a plurality of die elements that correspond in number and arrangement to the outlet openings of the respective set of outlet openings and/or to the punch elements. The punching device may comprise a punching station dedicated for cutting the sheet material 70 to obtain the carrier disk 8 comprising at least the set 8.1 and at least the set 8.4.

FIG. 21 shows an example of a punch element 110 used in an embodiment of the method to obtain one of the outlet openings 8. The punch element 110 is arranged opposite to a die 111 into which at least part of the punch element 110 can pass after passing through the sheet material 70. The sheet material 70 may be arranged between the die 111 and the punch element 110 before the punch element 110 passes through the sheet material 70 in order to cut the same. The punching station may comprise a stripper 112 (such as in the form of a plate), wherein the sheet material 70 may be arranged below the stripper 112 or between the stripper 112 and the die 111.

FIG. 22 exemplarily shows a punching process using the arrangement of FIG. 21. As shown, the punching process proceeds in four phases (a)-(d). In the first phase (a), the punch element 110 touches the sheet material 70, whereby the sheet material 70 is deformed. Then, in phases (b) and (c) the sheet material 70 is cut by the punch element 70. Finally, in phase (d), the tension within the material is so great that the sheet element 70 breaks along the contour of the cut. The cut-out piece of the sheet element 70—the so-called punching slug-is ejected away from the sheet element 70, in particular downwards, e.g. into the die 111. When the punch element 110 travels upward again, it can happen that it pulls the sheet element 70 along. In that case, the stripper 112 may be arranged to release the sheet material 70 from the punch element 110.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

### REFERENCES

1 capsule
2 capsule body/2a sidewalls
3 base wall
4 flange
5 lid
6 pull tab
7 carrier disk
8 outlet openings
8.1 First set of the outlet openings
8.11 First sub-set of the first set
8.12 Second sub-set of the first set
8.2 Second set of the outlet openings
8.21 First sub-set of the second set
8.22 Second sub-set of the second set
8.3 Third set of the outlet openings
8.31 First sub-set of the third set
8.32 Second sub-set of the third set
8.4 Fourth set of the outlet openings
8.5 Fifth set of the outlet openings
8.6 Sixth set of the outlet openings
9 filter
10 void-space
11 mechanical deformation/crimping
70 Sheet material
71 First alignment opening
72 Second alignment opening
73 Third alignment opening
75 Sheet moving direction
76 Sheet roll
101 First alignment element
102 Second alignment element
110 Punch element
111 Die
112 Stripper

1. A method for obtaining at least outlet openings for a carrier disk that can be provided in an inner space of a capsule for preparing a beverage, wherein the outlet openings are suitable for draining the prepared beverage from the inner space towards an outside of the capsule when the capsule is used in the beverage preparation device, wherein the method comprises:
providing a sheet material from which the carrier disk with the outlet openings is obtained,
cutting, by a cutting device, the sheet material to obtain a first set of the outlet openings,
aligning, by an alignment element extending through an alignment opening provided in the sheet material, the first set of the outlet openings relative to the cutting device,
cutting, by the cutting device, the sheet material with the [so] aligned first set of the outlet openings to obtain a second set of the outlet openings, and
moving the sheet material relative to the cutting device intermittently along different distances.

2. The method according to claim 1, further comprising:
aligning, by the alignment element extending through a further alignment opening provided in the sheet material, the first and second sets of the outlet openings relative to the cutting device, and
cutting, by the cutting device, the sheet material with the aligned first and second sets of the outlet openings to obtain a further set of the outlet openings.

3. The method according to claim 1- or 2, further comprising:
aligning, by a further alignment element extending through the alignment opening provided in the sheet material, the first and second sets of the outlet openings relative to the cutting device, and
cutting, by the cutting device, the sheet material with the aligned first and second sets of the outlet openings to obtain an additional set of the outlet openings.

4. The method according to claim 1, wherein at least part of the outlet openings of one of the first and second sets of the outlet openings is arranged among the outlet openings of the respective other set of the outlet openings.

5. The method according to claim 1, further comprising the step of cutting, by the cutting device, the sheet material to obtain the alignment opening.

6. The method according to claim 1, wherein the alignment opening is obtained in the step of cutting to obtain the first set of the outlet openings.

7. The method according to claim 1, further comprising cutting, by the cutting device, the sheet material to obtain the carrier disk such that the carrier disk comprises the first and second sets of the outlet openings.

8. The method according to claim 7, wherein the obtained carrier disk is void of outlet openings on its an external perimeter of the carrier disk over a distance of at least 1 mm.

9. The method according to claim 1, further comprising:
aligning, by using an alignment element extending through the alignment opening or through another alignment opening provided in the sheet material, the first and second sets of the outlet openings relative to the cutting device, and
cutting, by the cutting device, the sheet material to obtain the carrier disk such that the carrier disk comprises the aligned first and second sets of the outlet openings.

10. The method according to claim 1, wherein the cutting device is a punching device.

11. The method according to claim 1, wherein an outlet opening of one of the first and second sets of the outlet openings is spaced apart from an adjacent outlet opening of another set of the outlet openings with a distance comprised between 0.5 mm and 3 mm.

12. The method according to claim 1, wherein adjacent outlet openings of a same set of the outlet openings are spaced apart from one another with a distance greater than the distance between adjacent outlet openings of different sets of the outlet openings.

13. The method according to claim 1, wherein the outlet openings of the carrier disk or the first and second sets of the outlet openings comprise between 50 and 150 outlet openings.

14. The method according to claim 1, wherein the outlet openings have a diameter comprised between 0.4 mm and 3 mm.

15. The method according to claim 1, wherein the thickness of the sheet material is comprised between 0.05 mm and 1.5 mm.
